(19) United States
(12) Patent Application Publication
(10) Pub. No.: US 2008/0235729 A1
(43) Pub. Date: Sep. 25, 2008

(54) USER INTERFACE APPARATUS, DISPLAY METHOD, AND COMPUTER PROGRAM PRODUCT

(75) Inventors: Miwako DOI, Kanagawa (JP); Kaoru Suzuki, Kanagawa (JP); Toshiyuki Koga, Kanagawa (JP); Koichi Yamamoto, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/013,216

(22) Filed: Jan. 11, 2008

(30) Foreign Application Priority Data
Mar. 23, 2007 (JP) 2007-077582

(51) Int. Cl. H04N 5/445

(52) U.S. Cl. 725/43

(57) ABSTRACT

A content material of a first content which is reproducible constantly and content information describing information relating to a reproduction of a second content which is reproducible on a predetermined time and date are stored in a storage unit. A timewise characteristic or a characteristic relating to a reproducing state of the content material and/or the content information corresponding to operation candidate contents are determined. The operation candidate contents are list-displayed for each type of the characteristic, and an execution process corresponding to the characteristic of an operation candidate content is displayed as a processing candidate.

### CROSS-REFERENCE TO RELATED APPLICATIONS

This application is based upon and claims the benefit of priority from the prior Japanese Patent Application No. 2007-077582, filed on Mar. 23, 2007; the entire contents of which are incorporated herein by reference.

### BACKGROUND OF THE INVENTION

1. Field of the Invention

The present invention relates to a user interface apparatus, a display method, and a computer program product.

2. Description of the Related Art

With popularization of broadband technology, television (TV) terminals capable of receiving and viewing content materials such as a movie via the Internet have been growing. Further, TV terminals with a memory such as a hard disk are in widespread, and some of the TV terminals are capable of recording as well as receiving signals. In addition to the TV terminals, high-resolution audio video personal computers (AV-PCs) have recently been popular in the market. The AV-PCs are mainly used for viewing images transmitted by an analog method and terrestrial digital broadcasting method. With the AV-PCs, a received TV program can be recorded on a hard disk.

In such AV devices, operations thereof have become more complex with an increase of functions. For example, in the AV-PCs, a hierarchy menu for selecting commands becomes larger due to the complex nature of operation items, which causes a problem such that it is not clear with which menu the operation for an intended function can be performed. Likewise in the TV terminals, because buttons corresponding to many functions are used on a remote controller, the size of the controller becomes larger, thereby making it difficult to operate it by a hand. Further, it becomes difficult to find a button that corresponds to the operation of the intended function among many buttons.

To solve the above problems, there has been proposed an operation method in which a decrease of time-consuming search of many menus and buttons is attempted by recognizing a command corresponding to the intended function uttered by a user as speech. For example, in JP-A 2003-241795 (KOKAI), there is disclosed an interface in which a command desired by a user is expressed in a fixed sentence speech, a fixed portion in the fixed sentence is read, a slot portion is expressed by acoustic sound or speech simultaneously, and the user inputs speech to be input in the slot portion, so that a command can be instructed.

However, in the technique disclosed in JP-A 2003-241795 (KOKAI), it is difficult to estimate user's intention, thereby making it partial intention estimate and it is not practical. For example, in a situation where there is no guidance regarding the command for inputting speech, the user cannot understand the command to be uttered, and therefore speech input is not possible. Even when an operation is to be performed by a graphical user interface (GUI), the number of menus, icons, or buttons increases, thereby making the operation complicated.

Further, the operation button and the operation command generally become different according to the characteristic of the content material. Operation buttons and operation commands such as reproduction, reception, and recording (reserved) are generally different according to timewise characteristic regarding reproduction, for example, whether the content material as an operation target has been already recorded, is currently broadcast, or will be broadcast in the future. Further, the characteristic regarding the reproduction state, for example, whether the content material has been already reproduced or has not been reproduced yet, can be a reference to manage the content materials. Therefore, various operations such as edit and deletion are performed according to the characteristic. Because there can be various operations according to the characteristic of the content material, the operation becomes complicated.

### SUMMARY OF THE INVENTION

According to one aspect of the present invention, a user interface apparatus includes a first storage unit that stores a content material of a first content which is reproducible constantly and content information describing information relating to a reproduction of a second content which is reproducible on a predetermined time and date; a first receiving unit that receives an input of a search key; a search unit that searches at least one of the content material and the content information corresponding to the search key as operation candidate contents, from the first storage unit; a date-and-time measuring unit that measures current date and time; a characteristic determining unit that determines a timewise characteristic relating to reproduction of the operation candidate contents based on the current date and time; a first display unit that list-displays the operation candidate contents for each type of the characteristic determined by the characteristic determining unit; a second receiving unit that receives a selection instruction of a specific operation candidate content from the operation candidate contents displayed by the first display unit, and designates the content corresponding to the selection instruction as a content to be operated; a second storage unit that stores a processing candidate table in which each type of the characteristic is associated with one or a plurality of execution processes corresponding to each type of the characteristic; and a second display unit that displays an execution process corresponding to the characteristic of the content to be operated based on the processing candidate table stored in the second storage unit.

According to another aspect of the present invention, a user interface apparatus includes a first storage unit that stores a content material of a first content which is reproducible constantly, content information describing information relating to a reproduction of a second content which is reproducible on a predetermined time and date, and reproduced information indicating whether any of the first and second contents are reproduced, in association with each other; a first receiving unit that receives an input of a search key; a search unit that searches at least one of the content material and the content information corresponding to the search key as operation candidate contents, from the first storage unit; a characteristic determining unit that determines a characteristic relating to a reproduced state of the operation candidate content based on the reproduced information associated with the operation candidate contents; a first display unit that list-displays the operation candidate contents for each type of the characteristic determined by the characteristic determining unit; a second receiving unit that receives a selection instruction of a specific operation candidate content from the operation candidate contents displayed by the first display unit, and designates the content corresponding to the selection instruction as a content to be operated; a second storage unit that stores a processing candidate table in which each type of the characteristic is associated with one or a plurality of execution processes corresponding to each type of the characteristic; and a second display unit that displays an execution process corresponding to the characteristic of the content to be operated based on the processing candidate table stored in the second storage unit.

According to still another aspect of the present invention, a method of displaying user interface includes first receiving an input of a search key; searching at least one of a content material of a first content which is reproducible constantly and content information describing information relating to a reproduction of a second content which is reproducible on a predetermined time and date corresponding to the search key as operation candidate contents, from a first storage unit that stores the content material and the content information; measuring current date and time; determining a timewise characteristic relating to reproduction of the operation candidate content based on the current date and time; first list-displaying the operation candidate contents for each type of the characteristic determined in the determining; second receiving a selection instruction of a specific operation candidate content from the operation candidate contents displayed in the first displaying, and designating the content corresponding to the selection instruction as a content to be operated; and second displaying an execution process corresponding to the characteristic of the content to be operated based on the processing candidate table in which each type of the characteristic is associated with one or a plurality of execution processes corresponding to each type of the characteristic.

A computer program product according to still another aspect of the present invention causes a computer to perform the methods according to the present invention.

### BRIEF DESCRIPTION OF THE DRAWINGS

FIG. 1 is a block diagram illustrating a configuration of a user interface apparatus according to a first embodiment of the present invention;

FIG. 2 is a diagram illustrating an example of a program guide according to the first embodiment;

FIG. 3 is a diagram illustrating a display example of the program guide according to the first embodiment;

FIG. 4 is a diagram illustrating an example of additional information according to the first embodiment;

FIG. 5 is a block diagram illustrating an example of a functional configuration of the user interface apparatus according to the first embodiment;

FIG. 6 is a diagram illustrating an example of a display screen according to the first embodiment;

FIG. 7 is a diagram illustrating an example of a processing candidate table according to the first embodiment;

FIG. 8A is a diagram illustrating an example of the display screen according to the first embodiment;

FIG. 8B is a diagram illustrating another example of the display screen;

FIG. 8C is a diagram illustrating still another example of the display screen;

FIG. 9 is a flowchart of a display-control process procedure according to the first embodiment;

FIG. 10A is a diagram illustrating an example of the display screen according to the first embodiment;

FIG. 10B is a diagram illustrating another example of the display screen;

FIG. 10C is a diagram illustrating still another example of the display screen;

FIG. 11 is a flowchart of a procedure of a processing-candidate display process according to the first embodiment;

FIG. 12 is a diagram illustrating an example of a functional configuration of the user interface apparatus according to the first embodiment;

FIG. 13 is a block diagram illustrating an example of a functional configuration of a user interface apparatus according to a second embodiment of the present invention;

FIG. 14 is a diagram illustrating an example of additional information according to the second embodiment;

FIG. 15 is a diagram illustrating an example of a category determination table according to the second embodiment;

FIG. 16 is a diagram illustrating an example of a display screen according to the second embodiment;

FIG. 17 is a diagram illustrating an example of a processing candidate table according to the second embodiment;

FIG. 18A is a diagram illustrating an example of the display screen according to the second embodiment;

FIG. 18B is a diagram illustrating another example of the display screen;

FIG. 18C is a diagram illustrating another example of the display screen;

FIG. 19 is a flowchart of a display-control process procedure according to the second embodiment;

FIG. 20 is a flowchart of a procedure of a processing-candidate display process according to the second embodiment;

FIG. 21 is a block diagram illustrating an example of a functional configuration of a user interface apparatus according to a third embodiment of the present invention;

FIG. 22 is a diagram illustrating an example of a recipe;

FIG. 23 is a diagram illustrating an example of a cooking method;

FIG. 24 is a diagram illustrating another example of the cooking method;

FIG. 25 is a diagram illustrating an example of a display screen according to the third embodiment;

FIG. 26 is a diagram illustrating an example of a processing candidate table according to the third embodiment;

FIG. 27 is a flowchart of a display-control process procedure according to the third embodiment;

FIG. 28 is a flowchart of a procedure of a processing-candidate display process according to the third embodiment;

FIG. 29 is a block diagram illustrating an example of a functional configuration of a user interface apparatus according to a fourth embodiment of the present invention;

FIG. 30 is a diagram illustrating an example of a display screen according to the fourth embodiment;

FIG. 31 is a diagram illustrating an example of a processing candidate table according to the fourth embodiment;

FIG. 32 is a flowchart of a display-control process procedure according to the fourth embodiment; and

FIG. 33 is a flowchart of a procedure of a processing-candidate display process according to the fourth embodiment.

### DETAILED DESCRIPTION OF THE INVENTION

Exemplary embodiments of a user interface apparatus, a display method, and a computer program product according to the present invention will be explained below in detail with reference to the accompanying drawings.

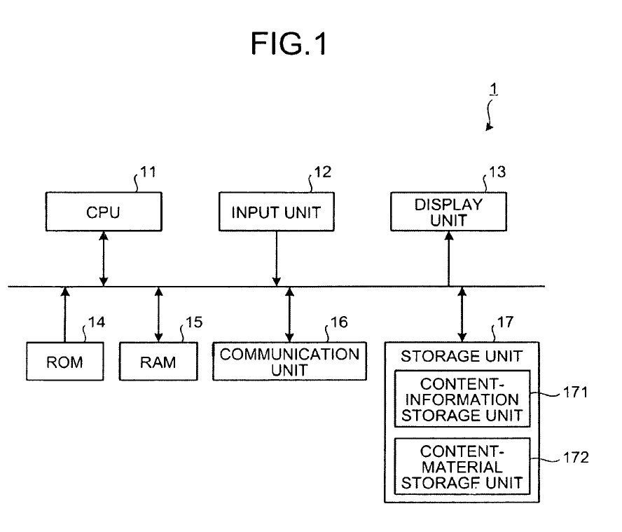

With reference to FIG. 1, a user interface apparatus 1 according to a first embodiment of the present invention is explained first. In the first embodiment, a user interface apparatus incorporated in a TV terminal, an AV-PC, and the like is explained.

FIG. 1 is a block diagram of a hardware configuration of the user interface apparatus 1. As shown in FIG. 1, the user interface apparatus 1 includes a central processing unit (CPU) 11, an input unit 12, a display unit 13, a read only memory (ROM) 14, a random access memory (RAM) 15, a communication unit 16, and a storage unit 17, and the respective units are connected with each other by a bus. User interface apparatuss 2 to 5 have the same hardware configuration as the user interface apparatus 1.

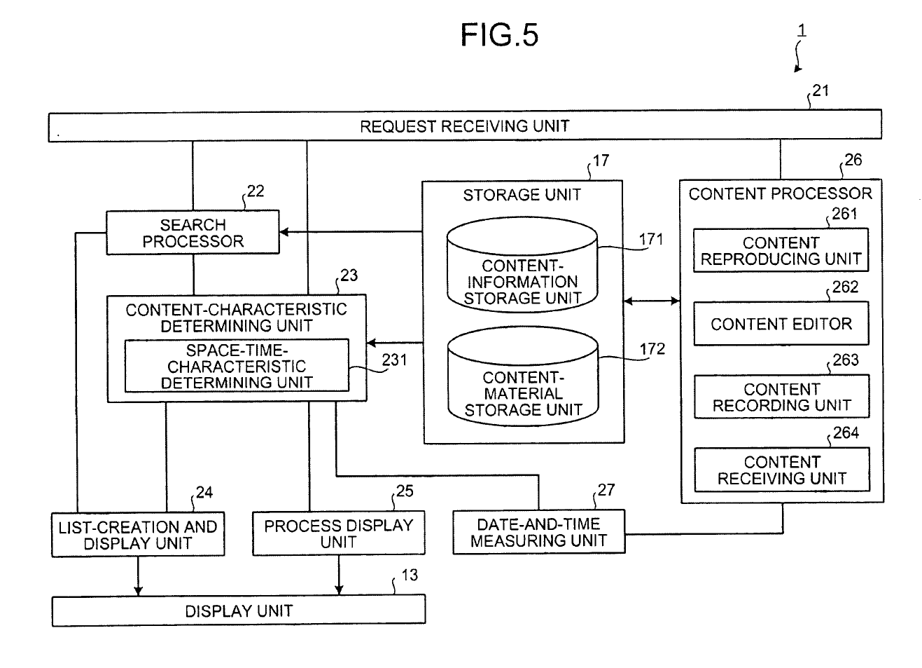

The CPU 11 executes various processes in cooperation with respective control programs pre-stored in the ROM 14 or the storage unit 17, using a predetermined area of the RAM 15 as a work area, to control the operation of respective units constituting the user interface apparatus 1. The CPU 11 realizes respective functional units of a request receiving unit 21, a search processor 22, a content-characteristic determining unit 23, a list-creation and display unit 24, a process display unit 25, a content processor 26, and a date-and-time measuring unit 27 (see FIG. 5) described later in cooperation with a predetermined program pre-stored in the ROM 14 or the storage unit 17. The respective functional units will be explained later in detail.

The input unit 12 is a remote controller, a keyboard, or a microphone for voice input. The input unit 12 receives information input from a user as an instruction signal and outputs the instruction signal to the CPU 11.

The display unit 13 includes a display device such as a liquid crystal display (LCD) and displays various pieces of information based on the display signal from the CPU 11.

The ROM 14 stores programs and various pieces of setting information non-rewritably under control of the user interface apparatus 1.

The RAM 15 is a volatile storage medium such as a synchronous dynamic random access memory (SDRAM), and functions as a work area of the CPU 11 to perform a role as a buffer and the like.

The communication unit 16 is an interface for communication with an external device via a network (not shown). The communication unit 16 outputs various pieces of information transmitted from the external device to the CPU 11 and transmits various pieces of information output from the CPU 11 to the external device.

The storage unit 17 includes a recording medium capable of recording magnetically or optically and stores a program and various pieces of setting information non-rewritably under control of the user interface apparatus 1. The storage unit 17 includes, in a storage area, a content-information storage unit 171 that stores a program guide and a content-material storage unit 172 that stores content materials of recorded motion pictures and photographs, music, and the like.

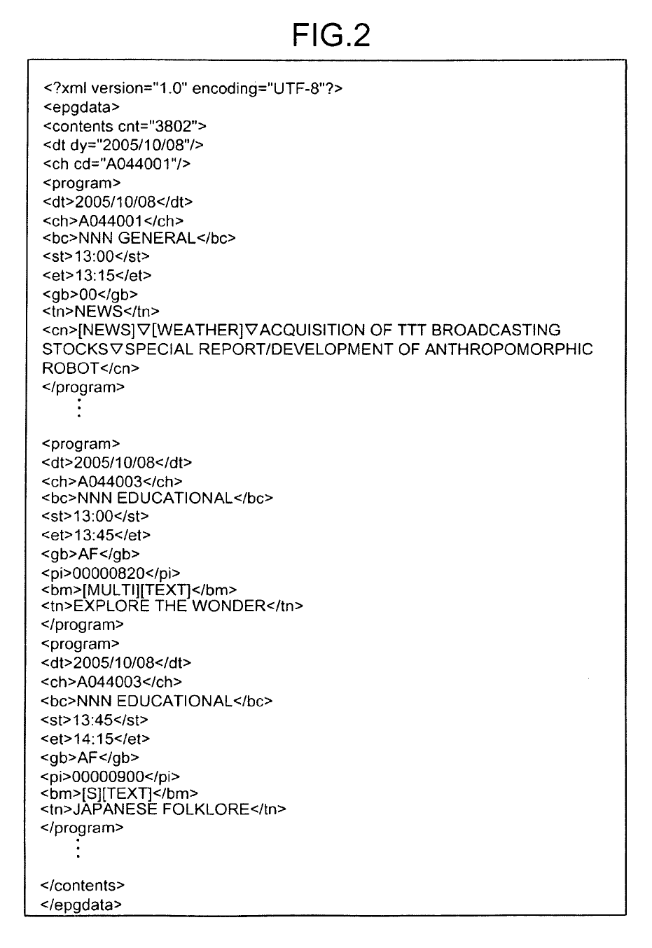

The program guide stored in the content-information storage unit 171 stores electronic program guide data referred to as an electronic program guide (EPG), and the content thereof is described in an extensible markup language (XML) format, for example, as shown in FIG. 2.

FIG. 2 is a diagram illustrating an example of the electronic program guide data. In FIG. 2, <?xml version=“1.0”encoding=“UTF-8”?> indicates that the electronic program guide data is described in the XML format, and text from <epgdata> to </epgdata> at the end indicates the EPG data.

Furthermore, <contents cnt=“3802”> indicates an ID of the obtained electronic program guide data, and <dt dy=“2005/10/08”/> indicates that the electronic program guide data was distributed on Oct. 8, 2005. Further, <ch cd=“A044001”/> indicates that the channel code is A04401. <program> indicates that the program guide data relating to the TV program follows below, and the end thereof is indicated by </program>. The program data from <program> to </program> is assumed as one content.

In the first <program>, <dt>2005/10/08</dt> indicates broadcast date when the TV program is broadcast, <ch>A044001<ch> indicates a channel code, and <bc>NNN General</bc> indicates a channel name. <st>13:00</st> indicates start time of the program, and <et>13:15</et> indicates end time of the program. Further, <gb>00</gb> indicates a genre of the program, and <tn>news</tn> indicates a program title. <cn>[news] V̅[weather] V̅acquisition of TTT broadcasting stocks V̅special report/development of anthropomorphic robot</cn> indicates a content of the program. Thereafter, programs put between “<program>” and “</program>” continue.

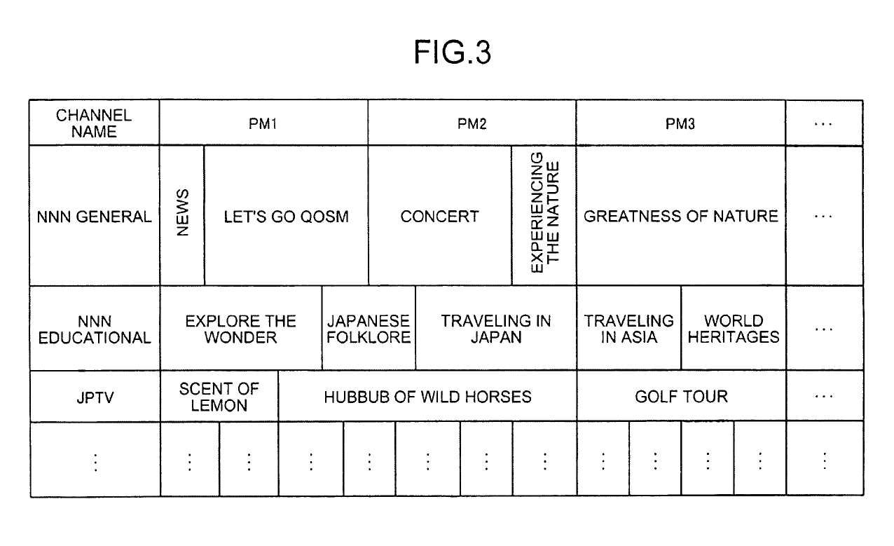

The program guide is displayed on the display unit 13 by the process display unit 25 described later easily observably by the user. FIG. 3 is a diagram illustrating a display example of the electronic program guide data displayed by the process display unit 25 described later. The program guide stored in the content-information storage unit 171 is displayed easily observably, when “program application” described later is instructed.

The content-material storage unit 172 stores the recorded motion picture data and music data as the contents that are reproducible constantly. The contents recorded by receiving the broadcast are stored in association with a part or all of the electronic program guide data (EPG data) shown in FIG. 2 as additional information.

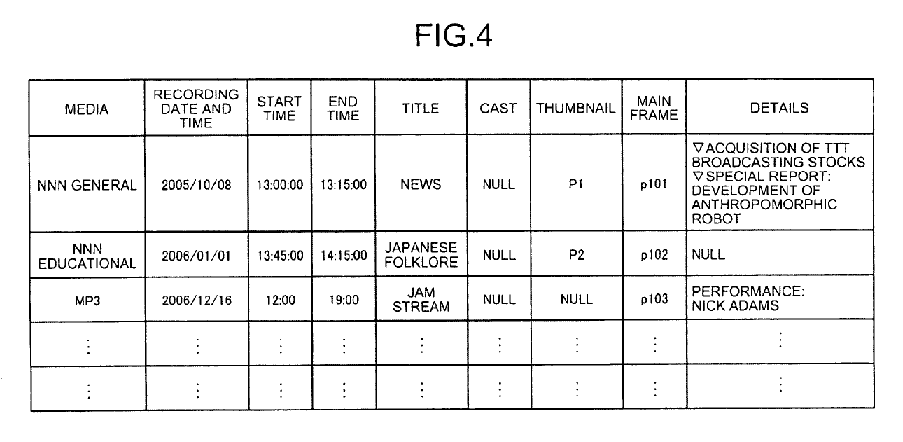

FIG. 4 is a diagram illustrating an example of the additional information stored in association with the contents of the content-material storage unit 172. As shown in FIG. 4, the additional information includes broadcasting station that has broadcast the content (program data), media type (media) indicating a file format and the like, recording date (recording date, start time, and end time), program title (title), program Cast (Cast) of the content, address of thumbnail images representing one screen of the content (thumbnail), address information (main part) in which a content main frame is present, and detailed information (details) relating to the contents such as the program content. The additional information is associated with the corresponding content based on the address stored in the “thumbnail” or the “main part”. In FIG. 4, “null” indicates that there is no corresponding information.

The respective functional units realized in cooperation with the program stored in the CPU 11 and the ROM 14 or the storage unit 17 is explained with reference to FIG. 5. FIG. 5 is a block diagram of the functional configuration of the user interface apparatus 1.

As shown in FIG. 5, the user interface apparatus 1 includes the request receiving unit 21, the search processor 22, the content-characteristic determining unit 23, the list-creation and display unit 24, the process display unit 25, the content processor 26, and the date-and-time measuring unit 27.

The request receiving unit 21 receives various pieces of instruction information input via the input unit 12.

The search processor 22 searches the relevant content from the content-information storage unit 171 and the content-material storage unit 172 based on a search request instructing search of a specific content received via the request receiving unit 21. The search request includes a search keyword such as the program title as a search key.

Specifically, the search processor 22 determines whether there is a character string matched with the search keyword in the information of the program title included in the respective contents (program data) described in the program guide in the content-information storage unit 171 and the information of the program title included in the additional information of the respective contents stored in the content-material storage unit 172, and outputs the matched content to the content-characteristic determining unit 23 as the search result.

The content-characteristic determining unit 23 includes a space-time-characteristic determining unit 231 to determine space-time characteristics of the respective contents searched by the search processor 22, and outputs the determination result to the list-creation and display unit 24 and the process display unit 25.

The space-time-characteristic determining unit 231 compares current date and time measured by the date-and-time measuring unit 27 with broadcast date and time of respective contents included in the electronic program guide data in the content-information storage unit 171 and determines the space-time characteristics of the respective contents.

Specifically, the space-time-characteristic determining unit 231 compares the current date and time measured by the date-and-time measuring unit 27 with the broadcast date of dt-tag, broadcast start time of st-tag, and broadcast end time of et-tag of the respective contents included in the electronic program guide data searched by the search processor 22. The broadcast date of dt-tag stands for a character string part put between <dt> and </dt>. The broadcast start time stands for a character string part put between <st> and </st>, and the broadcast end time of et-tag stands for a character string part put between <et> and </et>.

Among the respective contents of the electronic program guide data searched by the search processor 22, for the content whose current date and time is determined to be between the broadcast start time and the broadcast end time, the space-time-characteristic determining unit 231 determines the space-time characteristic thereof as “present”. For the content whose broadcast start time is after the current time (future), the space-time-characteristic determining unit 231 determines the space-time characteristic thereof as “future”.

Further, among the respective contents of the electronic program guide data searched by the search processor 22, for the content determined that past broadcast date and time than the current date and time is described, the space-time-characteristic determining unit 231 determines that the content cannot be viewed (received), excludes the content from the search result, and deletes the data relating to the content from the electronic program guide data.

On the other hand, because the respective contents in the content-material storage unit 172 searched by the search processor 22 have been already recorded, the space-time-characteristic determining unit 231 determines the space-time characteristic of the contents as “past”.

The list-creation and display unit 24 divides the respective contents searched by the search processor 22 into each type of the space-time characteristics based on the determination result obtained by the content-characteristic determining unit 23 and a list thereof is displayed on the display unit 13.

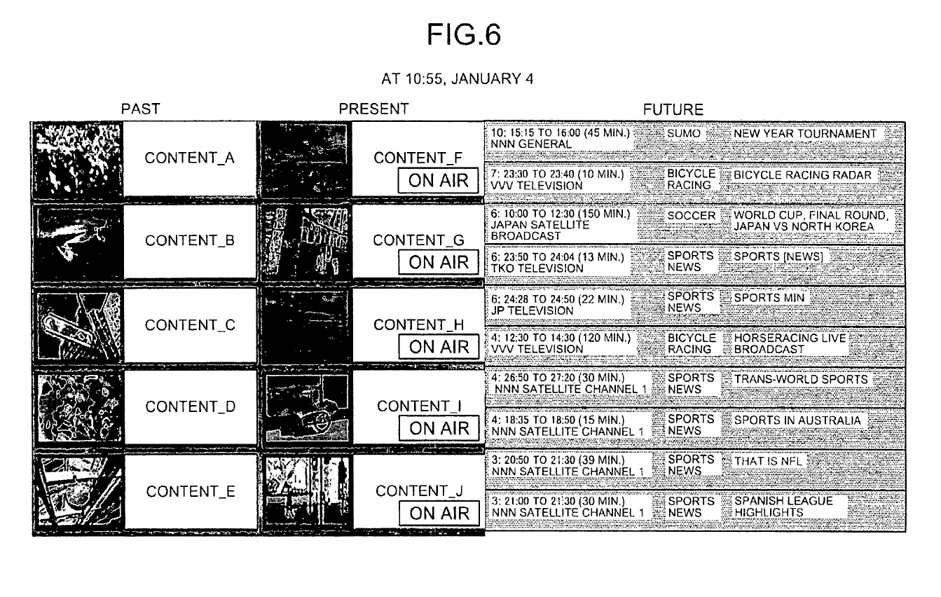

FIG. 6 is a diagram illustrating an example of a screen displayed on the display unit 13 by the list-creation and display unit 24. As shown in FIG. 6, the contents searched by the search processor 22 are listed in a state divided into “past”, “present”, and “future” according to the space-time characteristic thereof, under display control of the list-creation and display unit 24. “past” contents are displayed on the left of the screen, “present” contents are displayed in the middle, and “future” contents are displayed on the right of the screen. Because the “present” contents are on the air at present, “on the air” information indicating this matter is superimposed and displayed.

Returning to FIG. 5, the process display unit 25 displays various GUIs for supporting the operation of the user interface apparatus 1 on the display unit 13.

When an instruction signal for selecting a specific content from the list of the contents displayed by the list-creation and display unit 24 has been received by the request receiving unit 21, the process display unit 25 displays a processing candidate list indicating a predetermined execution process with respect to the relevant content on the display unit 13 according to the determination result by the content-characteristic determining unit 23. The process display unit 25 refers to the processing candidate table in which the type (past, present, and future) of the space-time characteristics pre-stored in the ROM 14 or the storage unit 17 is associated with the predetermined execution process, to display the execution process corresponding to the selected content on the display unit 13.

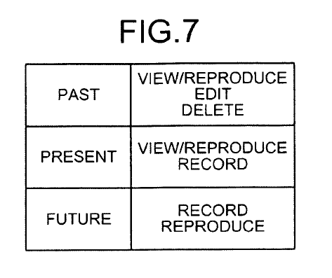

FIG. 7 is a diagram illustrating an example of the processing candidate table used in the first embodiment. As shown in FIG. 7, the type (past, present, and future) of the space-time characteristics is registered in the processing candidate table in association with the execution process that can be processed in each type. In the space-time characteristic “past”, “view/reproduce” that means reproduction of the content, “edit” that means edit of the content, and “delete” that means deletion of the content are registered in association with each other. In the space-time characteristic “present”, “view/reproduce” that means reproduction of the content and “record” that means recording are registered in association with each other. In the space-time characteristic “future”, “record” that means programming or recording of the content and “reproduce” that means reserved reproduction of the content are registered in association with each other.

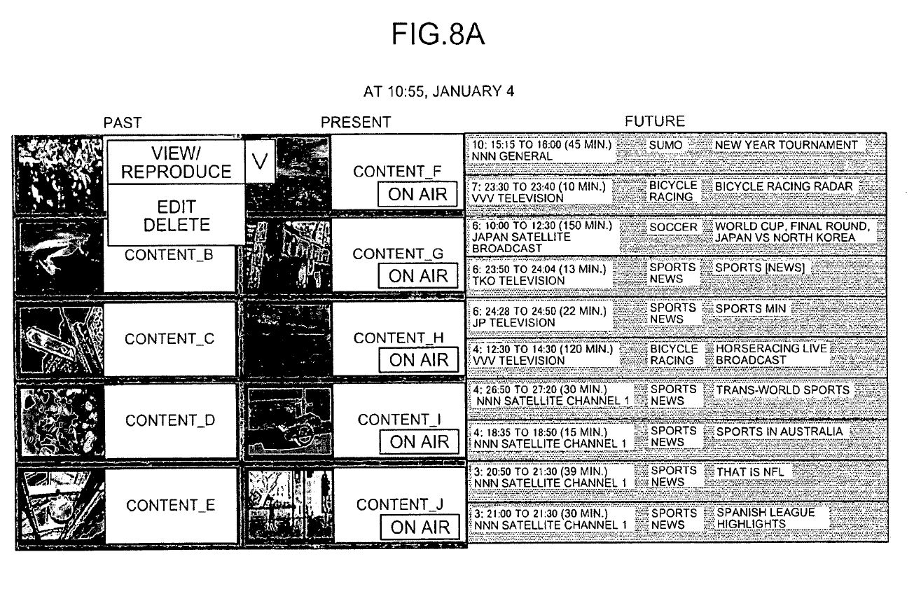

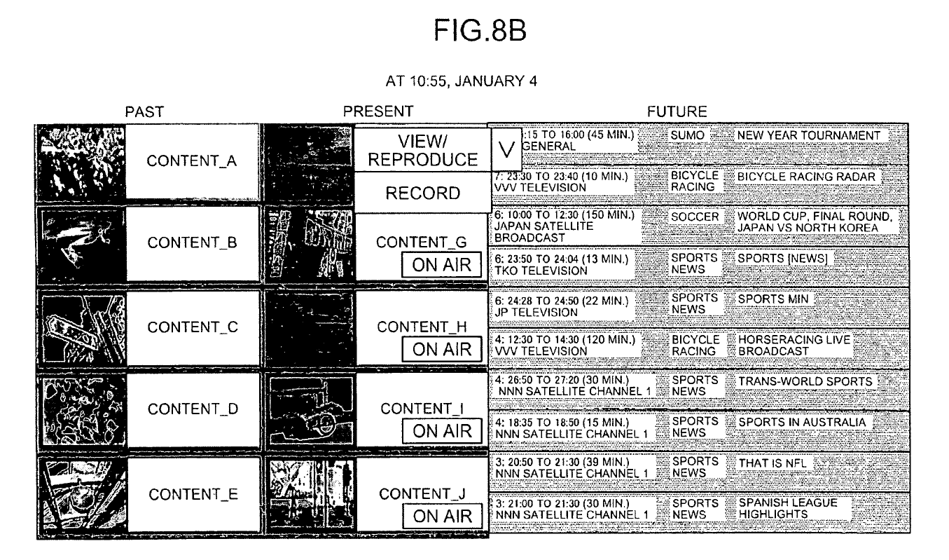

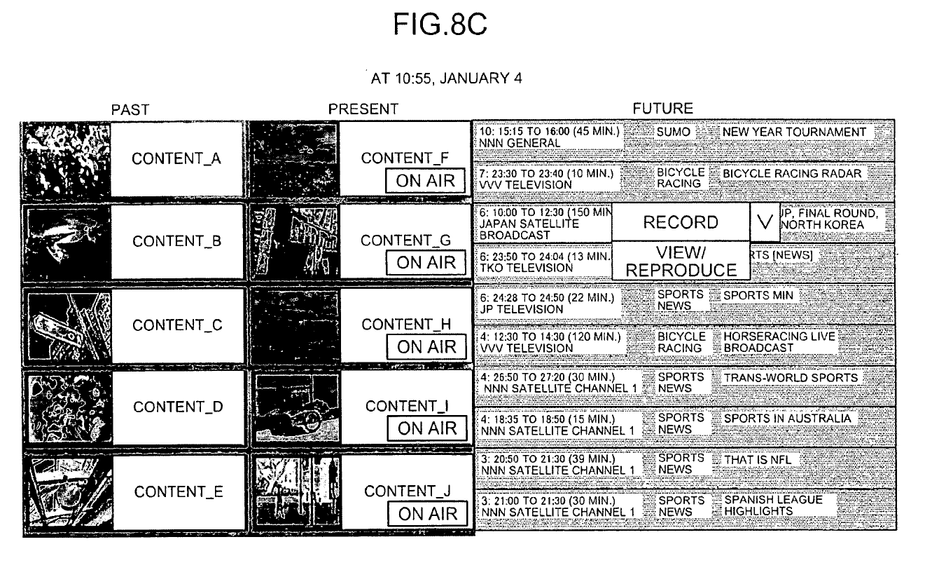

FIGS. 8A, 8B, and 8C are diagrams illustrating display examples of the processing candidate list displayed by the process display unit 25. FIG. 8A is a diagram illustrating a display example when the content having the space-time characteristic “past” is selected. As shown in FIG. 8A, the process display unit 25 superimposes on the content and displays the processing candidate list corresponding to the space-time characteristic “past” of the selected content.

The sequence of the execution process to be displayed as the processing candidate list is such that display is performed according to the order of registration of the execution process in the processing candidate table. That is, “view/reproduce” is displayed as the first processing candidate, “edit” is displayed as the second processing candidate, and “delete” is displayed as the third processing candidate, with respect to the content having the space-time characteristic “past”. The sequence of the execution process is preferably set according to the space-time characteristic.

FIG. 8B is a diagram illustrating a display example when the content having the space-time characteristic “present” is selected. The process display unit 25 refers to the processing candidate table and superimposes and displays, on the selected content, “view/reproduce” as the first processing candidate and “record” as the second processing candidate, as the processing candidate list corresponding to the space-time characteristic “present” of the selected content.

FIG. 8C is a diagram illustrating a display example when the content having the space-time characteristic “future” is selected. The process display unit 25 refers to the processing candidate table and superimposes and displays, on the selected content, “record” as the first processing candidate and “view/reproduce” as the second processing candidate, as the processing candidate list corresponding to the space-time characteristic “future” of the selected content.

The user can select the specific execution process from the processing candidate list displayed on the display unit 13 via the input unit 12, and the selected execution process is received as the instruction information by the request receiving unit 21.

Returning to FIG. 5, the content processor 26 includes a content reproducing unit 261, a content editor 262, a content recording unit 263, and a content receiving unit 264. These respective functional units execute various processes according to the execution process, when a specific execution process is instructed in the processing candidate list displayed on the process display unit 44 via the request receiving unit 21, relative to the specific content displayed on the display unit 13.

When “view/reproduce” is instructed in the processing candidate list relative to the specific content having the space-time characteristic “past”, the content reproducing unit 261 reads the content from the content-material storage unit 172 to reproduce the content. When “view/reproduce” is instructed in the processing candidate list relative to the specific content (program data) having the space-time characteristic “present”, the content reproducing unit 261 allows the content receiving unit 264 to receive and reproduce the content. When “view/reproduce” is instructed in the processing candidate list relative to the specific content (program data) having the space-time characteristic “future”, the content reproducing unit 261 allows the content receiving unit 264 to receive and reproduce the content at the program start time. When the content is sound data, “reproduction” means to display the sound data on the display unit 13, and when the content is audio data, “reproduction” means to produce sound from an acoustic system (not shown) such as a speaker.

When “edit” is instructed in the processing candidate list relative to the specific content having the space-time characteristic “past”, the content editor 262 displays display information (GUI) for supporting the edit of the content on the display unit 13. When “delete” is instructed in the processing candidate list relative to the content having the space-time characteristic “past”, the content editor 262 deletes the content and the additional information thereof from the content-material storage unit 172.

When “record” is instructed in the processing candidate list relative to the specific content (program data) having the space-time characteristic “present”, the content recording unit 263 allows the content receiving unit 264 to receive the content and stores the content in the content-material storage unit 172. When “record” is instructed in the processing candidate list relative to the specific content (program data) having the space-time characteristic “future”, the content recording unit 263 allows the content receiving unit 264 to receive the content at the program start time and stores the received content in the content-material storage unit 172. When storing the content in the content-material storage unit 172, the information included in the program data of the content is stored in the content-information storage unit 171 as the additional information of the content.

The content receiving unit 264 receives the TV program instructed by the program data based on the content (program data) instructed by the content reproducing unit 261 or the content recording unit 263.

The date-and-time measuring unit 27 measures the current date and time based on a clock signal generated by a clock generator or the like (not shown).

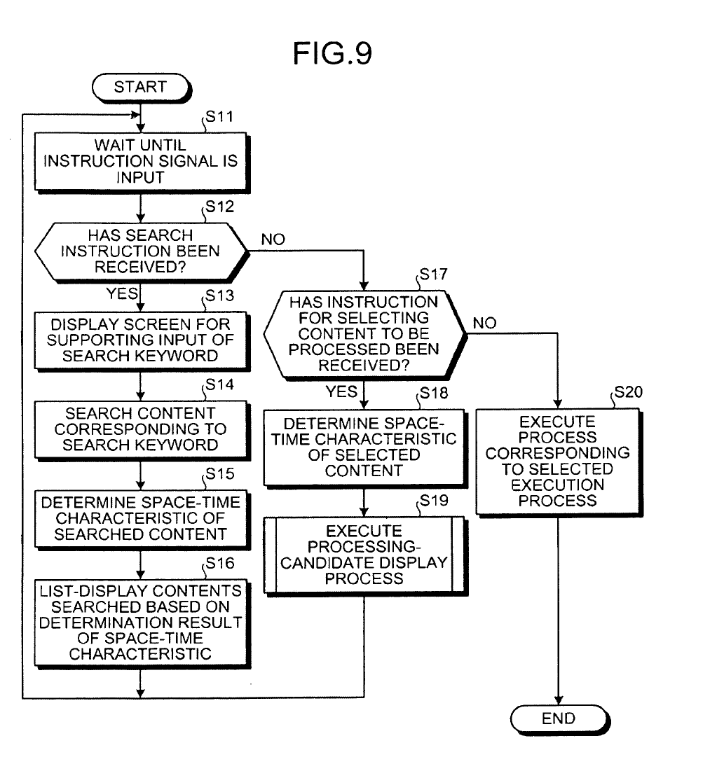

The operation of the user interface apparatus in the first embodiment is explained below with reference to FIGS. 9, 10A, 10B, 10C, and 11. FIG. 9 is a flowchart of a display-control process procedure performed by the user interface apparatus 1.

The process display unit 25 waits until the instruction signal is input via the input unit 12 (step S11). When determining that the instruction signal instructing search of a content has been received by the request receiving unit 21 (YES at step S12), the process display unit 25 displays the information (GUI) for supporting the input of the search keyword on the display unit 13 (step S13).

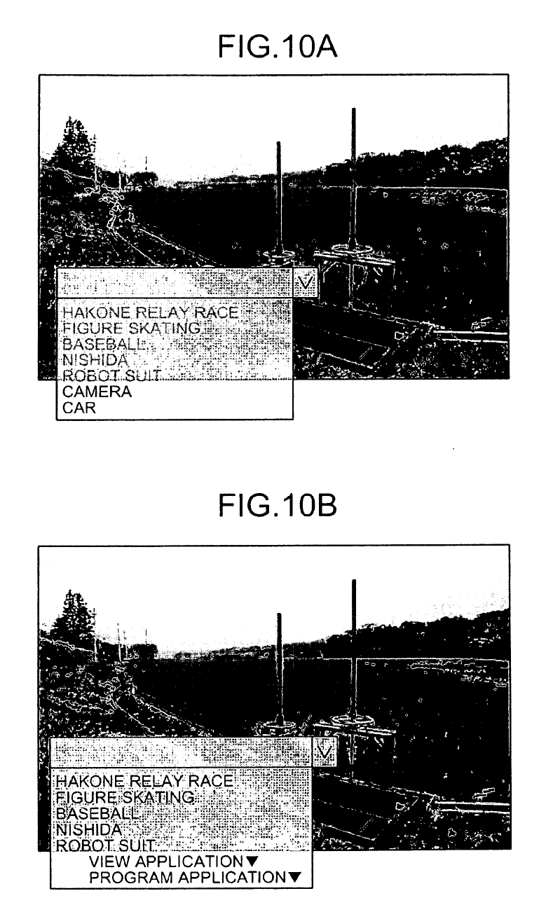

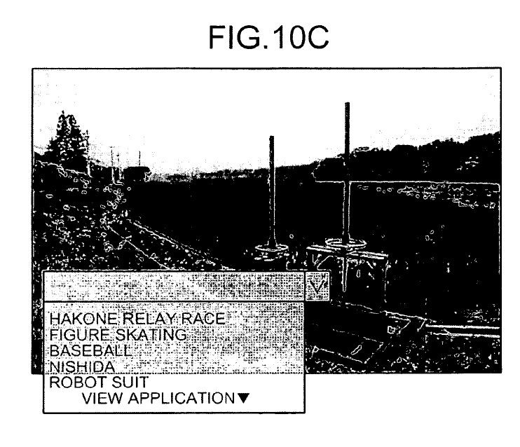

FIG. 10A is a diagram illustrating an example of the GUI displayed on the display unit 13 by the process at step S13. In FIG. 10A, the process display unit 25 supports input such as list display of the search keyword based on a history of the search keyword input in the past.

In FIG. 10A, only the search keyword input in the past is displayed, however, the display mode is not limited thereto. For example, as shown in FIG. 10B, items (shortcut) for instructing startup of an application (view application) for reproducing the content stored in the content-material storage unit 172, an application (program application) for displaying the program guide shown in FIG. 3, and the like can be displayed at the same time. When the content receiving unit 264 is not included, only the “view application” can be displayed as shown in FIG. 10C.

In the first embodiment, a case that a specific keyword (for example, “figure skating”) is selected from the list of the search keyword displayed as shown in FIG. 10A via the input unit 12 is explained, however, the input form of the keyword is not limited thereto, and an input form such that a character strings indicating, for example, a search keyword is input by keyboard input can be used.

Returning to FIG. 9, upon reception of the search keyword by the request receiving unit 21, the search processor 22 refers to the program guide (electronic program guide data) stored in the content-information storage unit 171 and the additional information of the respective contents stored in the content-material storage unit 172 to search the content including the character string matched with the input keyword (step S14).

The content-characteristic determining unit 23 determines the space-time characteristic of the respective contents searched at step S14, and outputs the determination result to the list-creation and display unit 24 together with the search result at step S14 (step S15). The list-creation and display unit 24 list-displays the contents searched based on the determination result at step S15 (step S16), and returns to step S11.

At step S11, upon reception of an instruction signal selecting the content to be processed from the contents list displayed at step S16 by the request receiving unit 21 (NO at step S12 and YES at step S17), the content-characteristic determining unit 23 determines the space-time characteristic of the selected content and outputs the determination result to the process display unit 25 (step S18).

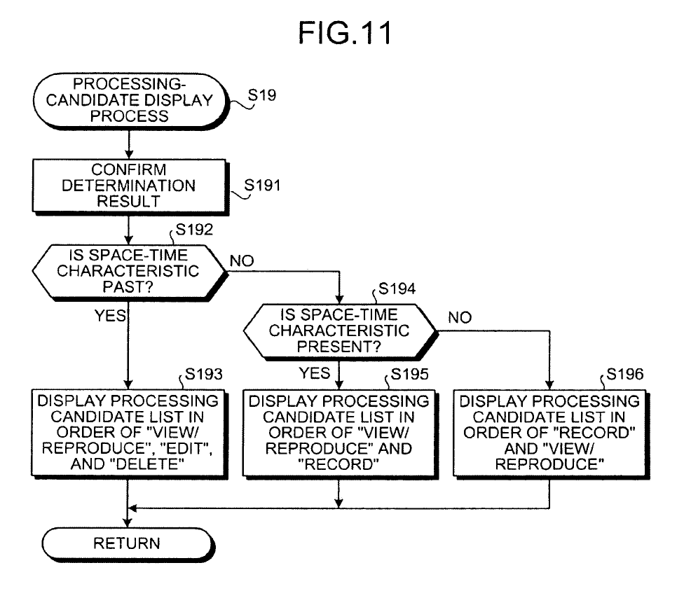

The process display unit 25 executes a processing-candidate display process (step S19) based on the determination result at step S18. The processing-candidate display process at step S19 is explained with reference to FIG. 11.

FIG. 11 is a flowchart of the procedure of the processing-candidate display process. At step S191, the process display unit 25 confirms the determination result (past, present, and future) at step S18. When determining that the determination result of the space-time characteristic at step S18 is “past” (YES at step S192), the process display unit 25 refers to the processing candidate table, and displays on the display unit 13 the processing candidate list corresponding to the space-time characteristic “past”, that is, the first processing candidate “view/reproduce”, the second processing candidate “edit”, and the third processing candidate “delete” (step S193), to return to step S11 in FIG. 9.

When determining that the determination result of the space-time characteristic at step S18 is “present” (NO at step S192 and YES at step S194), the process display unit 25 refers to the processing candidate table and displays on the display unit 13 the processing candidate list corresponding to the space-time characteristic “present”, that is, the first processing candidate “view/reproduce”, and the second processing candidate “record” (step S195), to return to step S11 in FIG. 9.

When determining that the determination result of the space-time characteristic at step S18 is “future” (NO at step S192 and NO at step S194), the process display unit 25 refers to the processing candidate table, and displays on the display unit 13 the processing candidate list corresponding to the space-time characteristic “future”, that is, the first processing candidate “record”, and the second processing candidate “view/reproduce”, (step S196), to return to step S11 in FIG. 9.

Returning to FIG. 9, at step S11, when the instruction signal selecting a specific execution process from the processing candidate list displayed at step S19 is received by the request receiving unit 21 (NO at step S12 and NO at step S17), the content processor 26 executes the process corresponding to the selected execution process (step S20) relative to the content to be processed, to finish the process.

According to the user interface apparatus 1 in the first embodiment, the execution process corresponding to the characteristic of the content can be presented to the user based on the timewise characteristic (space-time characteristic) relating to reproduction of the content selected as an operation target. Accordingly, because the screens according to the instruction input of the various execution processes can be unified regardless of the space-time characteristic of the respective contents, the operability can be improved and user's convenience can be improved.

In the first embodiment, only the contents included in the content-information storage unit 171 and the content-material storage unit 172 are designated as display (operation) targets, however, the display targets are not limited thereto. For example, the electronic program guide data stored in the external device outside of the user interface apparatus 1 and on-demand data can be the display target.

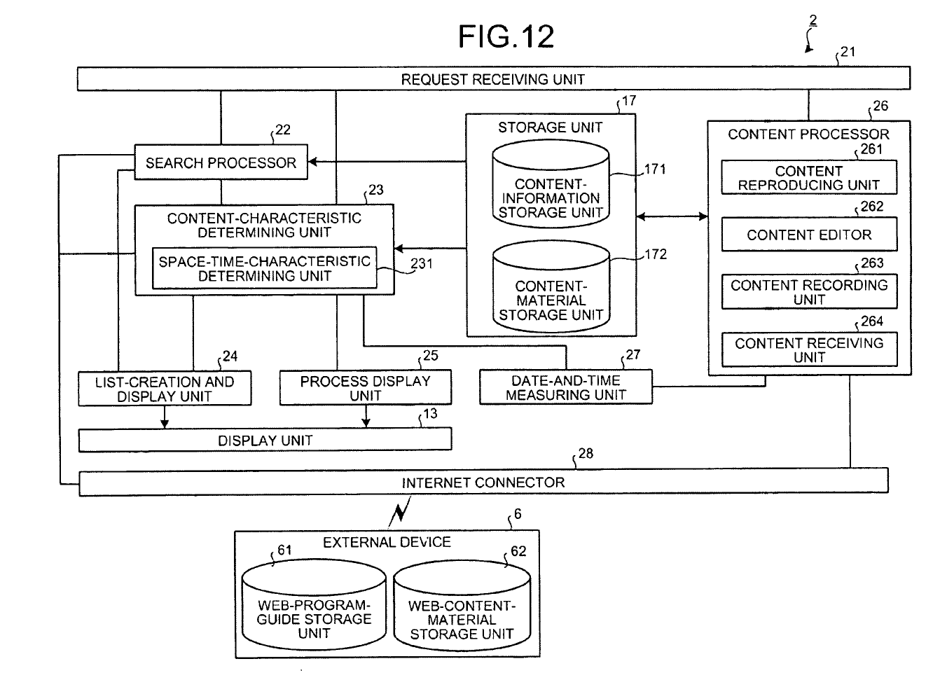

FIG. 12 is a diagram illustrating an example of a functional configuration of a user interface apparatus 2 according to another example in which the content from an external device 6 is used. In FIG. 12, an Internet connector 28 is a functional unit that obtains the content from the external device 6 connected to the network (not shown).

The external device 6 includes a Web-program-guide storage unit 61 that stores the program guide in the same format as that of the electronic program guide stored in the content-information storage unit 171 on demand, and a Web-content-material storage unit 62 that stores contents such as motion picture data.

In the configuration shown in FIG. 12, the user interface apparatus 2 obtains the content from the external device 6 via the Internet connector 28 so that the user interface apparatus 2 can handle the Web-program-guide storage unit 61 and Web-content-material storage unit 62 in the same manner as the content-information storage unit 171 and the content-material storage unit 172.

In the first embodiment, when a specific content is selected, the execution process corresponding to the space-time characteristic of the content is list-displayed, however, the present invention is not limited thereto. For example, when there is only one execution process, the execution process is not displayed, and the process corresponding to the execution process can be immediately executed by the content processor 26.

A user interface apparatus 3 according to a second embodiment of the present invention is explained next. Like reference numerals refer to like configuration in the first embodiment and explanations thereof will be omitted.

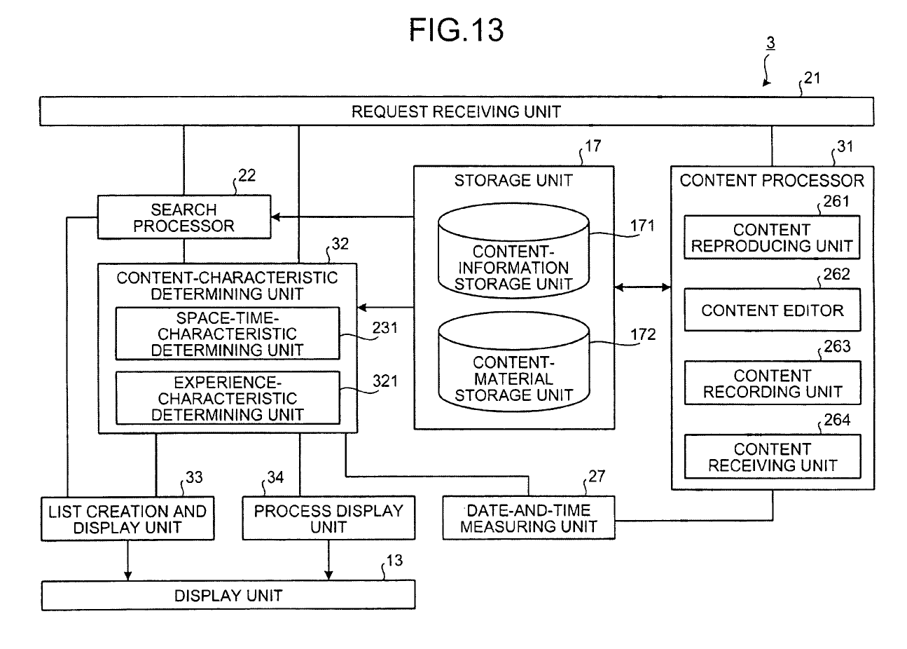

FIG. 13 is a block diagram of a functional configuration of the user interface apparatus 3. As shown in FIG. 13, the user interface apparatus 3 according to the second embodiment includes a content processor 31, a content-characteristic determining unit 32, a list-creation and display unit 33, and a process display unit 34, respectively, instead of the content processor 26, the content-characteristic determining unit 23, the list-creation and display unit 24, and the process display unit 25 explained in FIG. 5.

The content processor 31 includes the same functional unit as that of the content processor 26. The content processor 31 stores the present date and time measured by the date-and-time measuring unit 27 as the date and time when reproduction is performed (hereinafter, as reproduction date and time) in association with the content, when the respective contents included in the electronic program guide data and the contents in the content-material storage unit 172 are reproduced by the content reproducing unit 261.

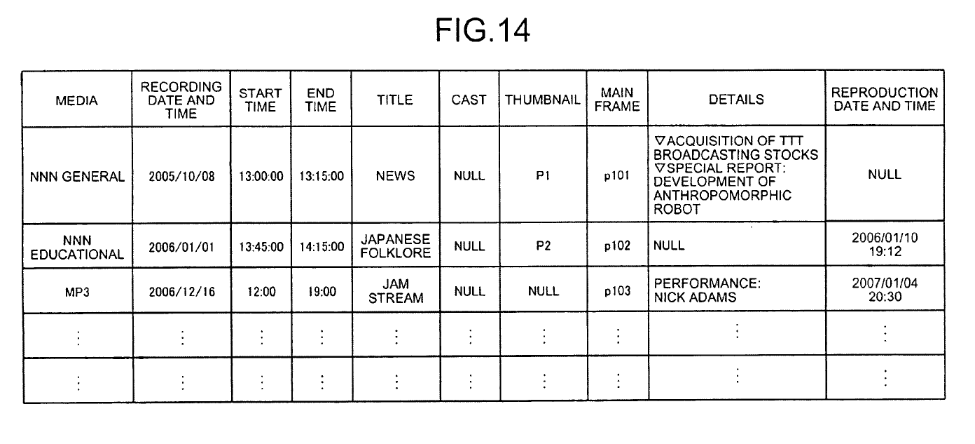

Specifically, the content processor 31 stores the reproduction date and time in association with the additional information of the reproduced content, as shown in FIG. 14, with respect to the respective contents of the content-material storage unit 172. FIG. 14 is a diagram illustrating an example of the additional information of the respective contents stored in the content-material storage unit 172, in which it can be determined whether the respective contents have been reproduced based on presence of the reproduction date and time. The reproduction date and time can be updated every time when the reproduction is performed, or a plurality of reproduction date and time can be stored as a reproduction history.

The content processor 31 generates a reproduced list in which the program data of the content and the reproduction date and time are associated with each other and stores the list in a predetermined area of the storage unit 17, also for the contents among the program guide in the content-information storage unit 171, for which only reception (viewing) of broadcast is performed by the content receiving unit 264 without recording them in the content material storage unit 172. In the reproduced list generated here, “recording date and time”, “start time”, “end time” and “main frame” are removed from the additional information shown in FIG. 14. The reproduction date and time can be updated every time of viewing or a plurality of reproduction date and times can be stored as a view history.

The content-characteristic determining unit 32 includes the space-time-characteristic determining unit 231 and an experience-characteristic determining unit 321, and determines the space-time characteristic and experience characteristic of respective contents based on various pieces of information included in the additional information associated with the program data of the respective contents described in the program guide in the content-information storage unit 171 or respective contents in the content-material storage unit 172.

The experience-characteristic determining unit 321 determines whether the respective contents have been viewed/reproduced (experienced) based on the reproduction date and time stored in association with the respective contents. Specifically, the experience-characteristic determining unit 321 determines that the experience characteristic of the content, which is registered in the reproduced list, is “experienced”, and the experience characteristic of the content, which is not registered in the reproduced list, is “unexperienced”, with respect to the respective contents included in the program guide in the content-material storage unit 172 searched by the search processor 22.

The experience-characteristic determining unit 321 further determines that the experience characteristic of the contents, for which the reproduced date and time are stored in association with the additional information of the respective contents, is “experienced” and the experience characteristic of the contents, for which the reproduced date and time are not stored in association therewith, is “unexperienced”, with respect to the respective contents in the content-material storage unit 172 searched by the search processor 22.

The space-time-characteristic determining unit 231 determines the space-time characteristic of the respective contents searched by the search processor 22 as in the first embodiment.

The list-creation and display unit 33 displays the list of the contents searched by the search processor 22 on the display unit 13 based on the determination result by the content-characteristic determining unit 32.

Specifically, the list-creation and display unit 33 divides the respective contents into three categories of “reproduced”, “currently reproducible”, and “reproducible in future” based on the determination result of the space-time characteristic of “past”, “present”, and “future” by the space-time-characteristic determining unit 231 and the determination result of the experience characteristic of “experienced” and “unexperienced” by the experience-characteristic determining unit 321, and list-displays the categories on the display unit 13.

At the time of dividing the contents into respective categories, the list-creation and display unit 33 divides the respective contents into three categories of “reproduced”, “currently reproducible”, and “reproducible in future” based on a category determination table pre-stored in the ROM 14 or the storage unit 17. The category determination table is explained below.

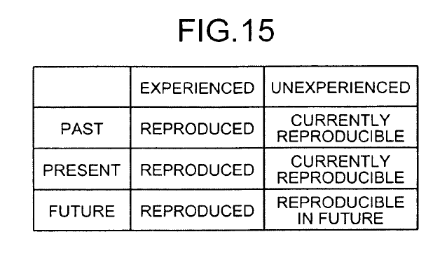

FIG. 15 is a diagram illustrating an example of the category determination table. As shown in FIG. 15, the category determination table is formed such that respective categories (“reproduced”, “currently reproducible”, and “reproducible in future”) can be unequivocally derived from a combination of the determination result (“past”, “present”, and “future”) of the space-time characteristic by the space-time-characteristic determining unit 231 and the determination result (“experienced” and “unexperienced”) of the experience characteristic by the experience-characteristic determining unit 321. The list-creation and display unit 33 determines the category of the content searched by the search processor 22 based on the determination result by the space-time-characteristic determining unit 231 and the experience-characteristic determining unit 321.

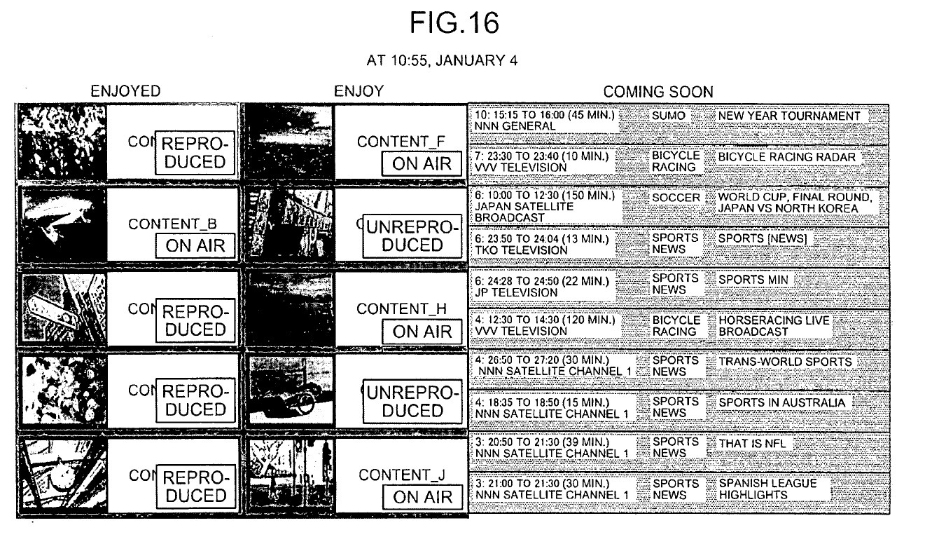

FIG. 16 is a diagram illustrating an example of the screen displayed on the display unit 13 by the list-creation and display unit 33. In FIG. 16, the categories are list-displayed such that the category “reproduced” is positioned on the left, the category “currently reproducible” is positioned in the middle, and the category “reproducible in future” is positioned on the right. For the contents belonging to the category “reproduced”, information indicating this matter, “reproduced”, is superimposed and displayed. For the contents belonging to the category “currently reproducible”, information indicating this matter, “on the air”, or “unreproduced” is superposed and displayed according to the media type of the content. On the upper part of the contents list, the current date and time is displayed, and the respective categories are rephrased and displayed as “enjoyed”, “enjoy”, and “coming soon”.

In category “reproduced” in FIG. 16, contents with category “currently reproducible” superimposed with “on the air” is displayed. This is because the content similar to the content is included in the category “reproduced”. The similar content stands for a version edited from one perfect form according to each application, and for example, a plurality of versions such as “uncut film” for theatrical exhibition or “television” version can be mentioned for the same title of video features such as a movie.

At the time of list-display of the respective contents, the list-creation and display unit 33 compares the program title and the content included in the program data of the respective contents and the additional information, and when determining that these are similar contents, the list-creation and display unit 33 places the similar contents side by side. By displaying in this manner, comparison by visual recognition of the contents is facilitated, thereby improving user's convenience. The display mode is not limited to the one shown in FIG. 16, and can be such that similarity determination is not included.

When a specific content is selected via the input unit 12 from the contents list displayed by the list-creation and display unit 33, the process display unit 34 displays on the display unit 13 the processing candidate list indicating the execution process relative to the content according to the determination result by the content-characteristic determining unit 32.

Specifically, the process display unit 34 determines the processing candidate list to be displayed based on the processing candidate table pre-stored in the ROM 14 or the storage unit 17 at the time of displaying the processing candidate list. The processing candidate table used in the second embodiment is explained below.

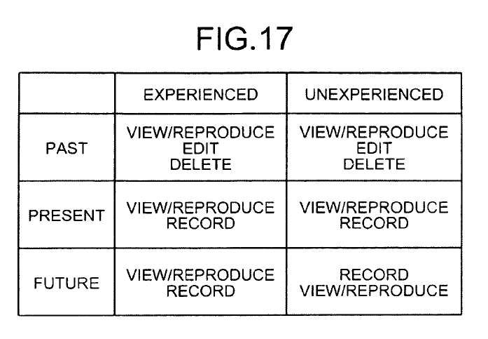

FIG. 17 is a diagram illustrating an example of the processing candidate table used in the second embodiment. As shown in FIG. 17, the processing candidate table is formed such that respective execution processes can be unequivocally derived from a combination of the determination result (“past”, “present”, and “future”) of the space-time characteristic by the space-time-characteristic determining unit 231 and the determination result (“experienced” and “unexperienced”) of the experience characteristic by the experience-characteristic determining unit 321. The process display unit 34 refers to the processing candidate table, and displays the execution process corresponding to the space-time characteristic and the experience characteristic of the content selected via the input unit 12 on the display unit 13 as the processing candidate list.

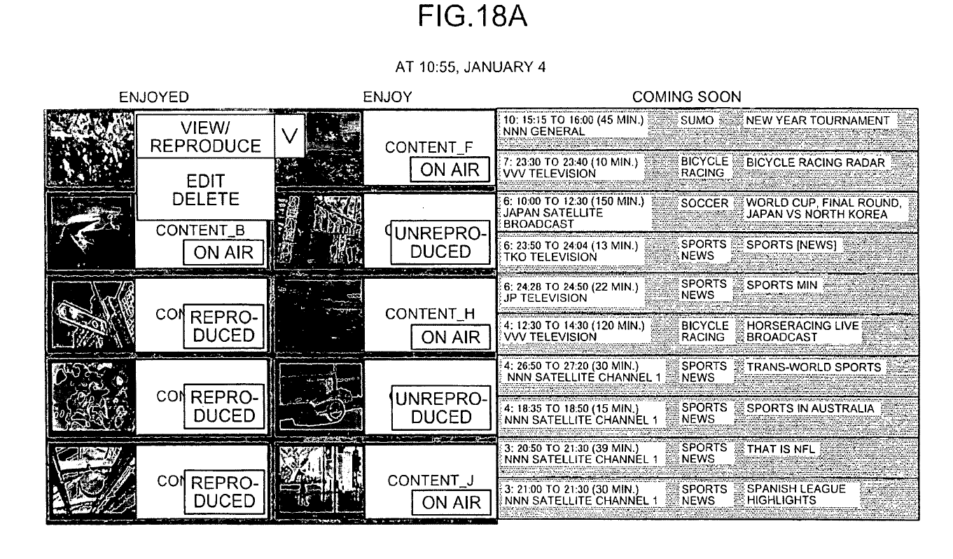

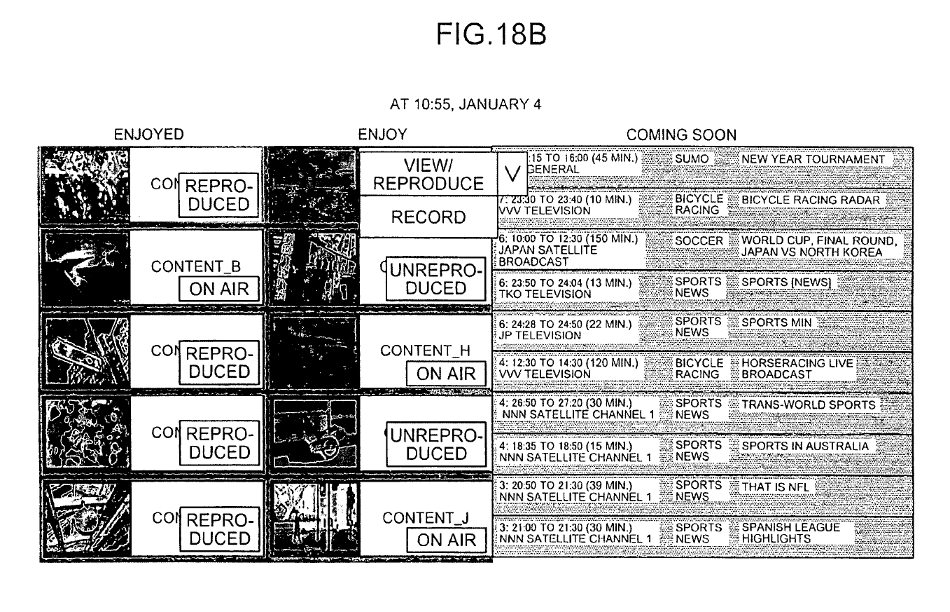

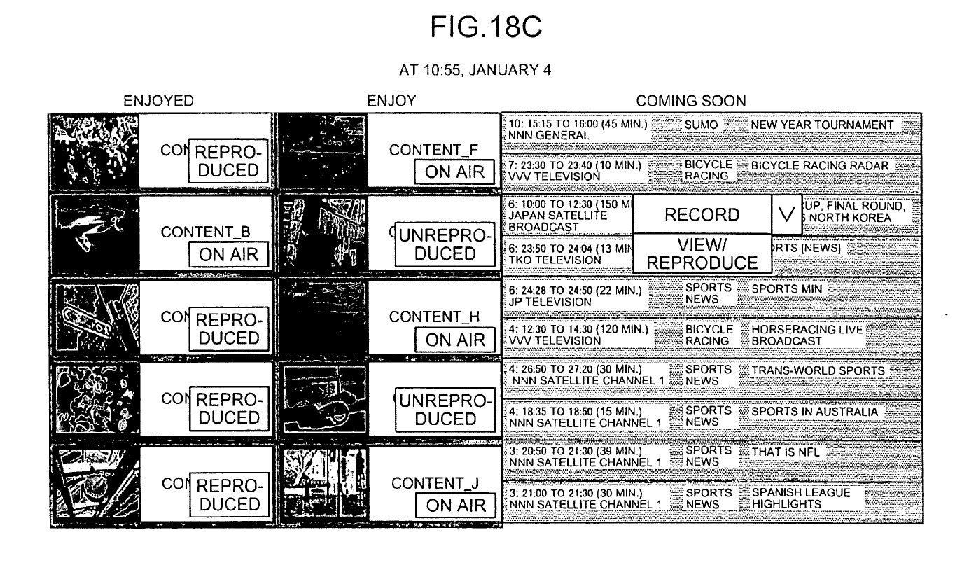

FIGS. 18A, 18B, and 18C are diagrams illustrating display examples of the processing candidate list displayed by the process display unit 34. FIG. 18A is a diagram illustrating a display example when a content having the space-time characteristic “past” and the experience characteristic “experienced” or “unexperienced” is selected via the input unit 12. As shown in FIG. 18A, the process display unit 34 superimposes on the selected content and displays the processing candidate list corresponding to the space-time characteristic and the experience characteristic of the selected content. The sequence of the execution process to be displayed as the processing candidate list is such that display is performed according to the order of registration of the execution process in the processing candidate table. That is, “view/reproduce” is displayed as the first processing candidate, “edit” is displayed as the second processing candidate, and “delete” is displayed as the third processing candidate, with respect to the content having the space-time characteristic “past” and experience characteristic is “experienced” or “unexperienced”.

FIG. 18B is a diagram illustrating a display example when the content having the space-time characteristic “present” and experience characteristic “experienced” or “unexperienced” is selected. The process display unit 34 refers to the processing candidate table and superimposes and displays on the selected content “view/reproduce” as the first processing candidate and “record” as the second processing candidate, as the processing candidate list corresponding to the space-time characteristic and the experience characteristic of the selected content.

FIG. 18C is a diagram illustrating a display example when the content having the space-time characteristic “future” and the experience characteristic “unexperienced” is selected. As shown in FIG. 18C, the process display unit 34 refers to the processing candidate table and superimposes and displays, on the selected content, “record” as the first processing candidate and “view/reproduce” as the second processing candidate, as the processing candidate list corresponding to the space-time characteristic and the experience characteristic of the selected content. In the second embodiment, the same processing candidate list is displayed regardless of the experience characteristic in the space-time characteristic “past” and “present”, however, the display mode is not limited thereto.

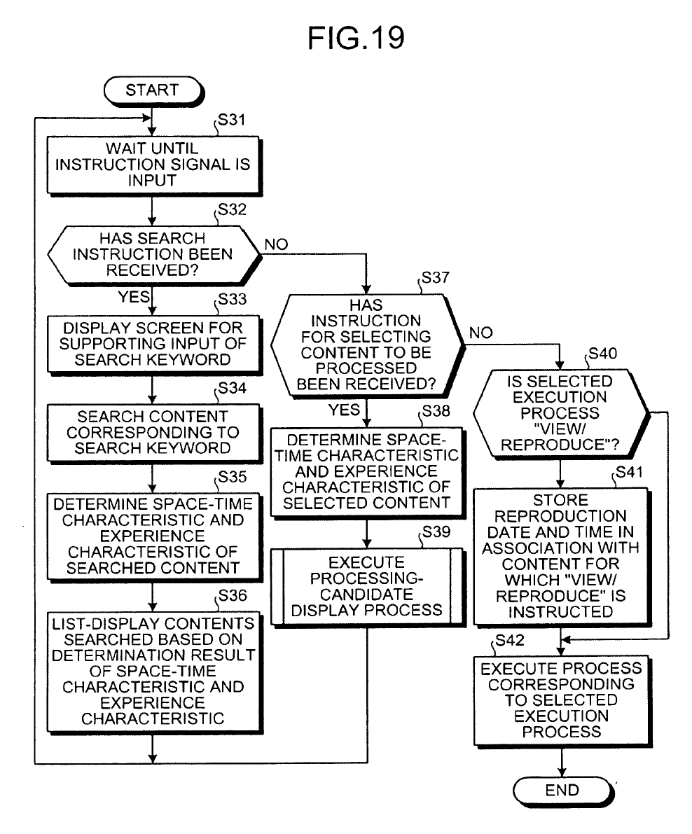

The operation of the user interface apparatus 3 according to the second embodiment is explained with reference to FIG. 19. FIG. 19 is a flowchart of a display-control process procedure performed by the user interface apparatus 3.

The process display unit 34 waits until the instruction signal is input via the input unit 12 (step S31). When determining that the instruction signal instructing search of a content has been received by the request receiving unit 21 (YES at step S32), the process display unit 34 displays the GUI for supporting the input of the search keyword on the display unit 13 (step S33).

Upon reception of the search keyword by the request receiving unit 21, the search processor 22 searches for the content including the character string matched with the input keyword from the program guide stored in the content-information storage unit 171 and the additional information of the respective contents stored in the content-material storage unit 172 (step S34).

The content-characteristic determining unit 32 determines the space-time characteristic of the respective contents searched at step S34 based on the current time, and also determines the experience characteristic based on the reproduction time stored in association with the respective contents and outputs the determination result to the list-creation and display unit 33 (step S35). The list-creation and display unit 33 list-displays the respective contents searched at step S34 based on the determination result at step S35 for each type of category (step S36), and returns to step S31.

At step S31, upon reception of an instruction signal selecting the content to be processed from the contents list displayed at step S36 by the request receiving unit 21 (NO at step S32 and YES at step S37), the content-characteristic determining unit 32 determines the space-time characteristic and the experience characteristic of the selected content and outputs the determination result to the process display unit 34 (step S38).

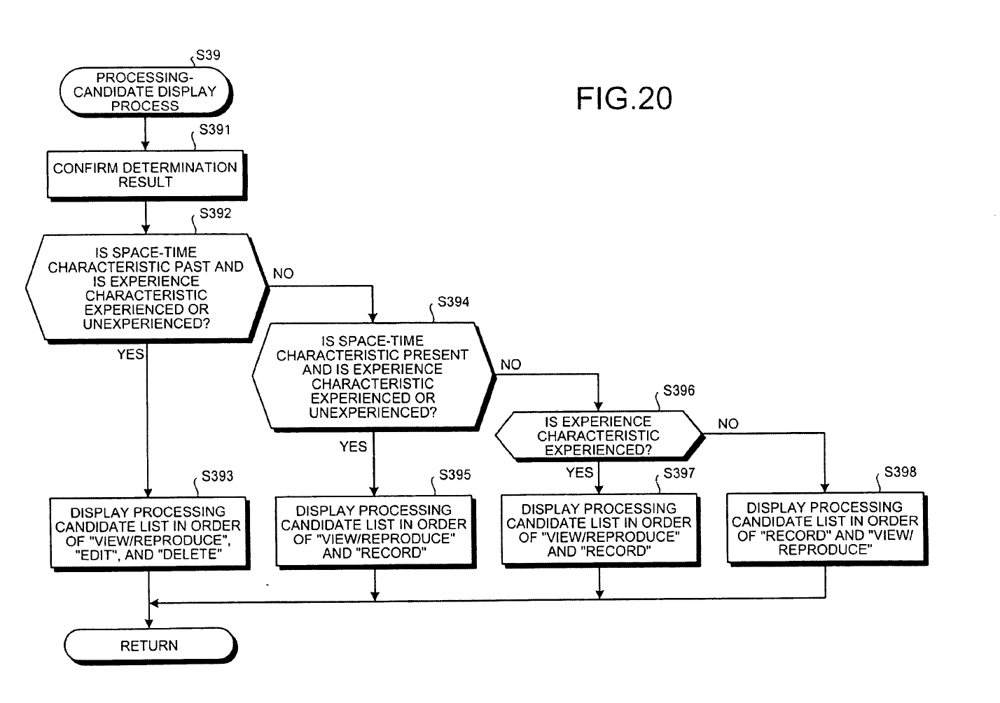

The process display unit 34 executes a processing-candidate display process (step S39) based on the determination result at step S38. The processing-candidate display process at step S39 is explained with reference to FIG. 20.

FIG. 20 is a flowchart of the procedure of the processing-candidate display process at step S39. At step S391, the process display unit 34 confirms the determination result at step S38 (step S391). When determining that the determination results of the space-time characteristic and the experience characteristic at step S38 are, respectively, “past” and “experienced” or “unexperienced” (YES at step S392), the process display unit 54 refers to the processing candidate table, and displays on the display unit 13 the processing candidate list corresponding to the space-time characteristic and the experience characteristic, that is, the first processing candidate “view/reproduce”, the second processing candidate “edit”, and the third processing candidate “delete” (step S393), to return to step S31 in FIG. 19.

When determining that the determination results of the space-time characteristic and the experience characteristic at step S38 are, respectively, “present” and “experienced” or “unexperienced” (NO at step S392 and YES at step S394), the process display unit 34 refers to the processing candidate table and displays on the display unit 13 the processing candidate list corresponding to the space-time characteristic and the experience characteristic, that is, the first processing candidate “view/reproduce”, and the second processing candidate “record” (step S395), to return to step S31 in FIG. 19.

When determining that the determination results of the space-time characteristic and the experience characteristic at step S38 are, respectively, “future” and “experienced” (NO at step S392, NO at step S394, and YES at step S396), the process display unit 34 refers to the processing candidate table, and displays on the display unit 13 the processing candidate list corresponding to the space-time characteristic and the experience characteristic, that is, the first processing candidate “view/reproduce”, and the second processing candidate “record”, (step S397), to return to step S31 in FIG. 19.

When determining that the determination results of the space-time characteristic and the experience characteristic at step S38 are, respectively, “future” and “unexperienced” (NO at step S392, NO at step S394, and NO at step S396), the process display unit 34 refers to the processing candidate table, and displays on the display unit 13 the processing candidate list corresponding to the space-time characteristic and the experience characteristic, that is, the first processing candidate “record”, and the second processing candidate “view/reproduce”, (step S398), to return to step S31 in FIG. 19.

Returning to FIG. 19, at step S31, when the instruction signal selecting a specific execution process from the processing candidate list displayed at step S39 is received by the request receiving unit 21 (NO at step S32 and NO at step S37), the content processor 31 determines whether the selected execution process is “view/reproduce” (step S40). When determining that the execution process is other than “view/reproduce”, that is, “edit”, “delete”, or “record” of the contents is instructed (NO at step S40), the content processor 31 executes the process corresponding to the selected execution process (step S42) relative to the content to be processed, to finish the process.

On the other hand, at step S40, when determining that “view/reproduce” is selected (YES at step S40), the content processor 31 stores the current date and time measured by the date-and-time measuring unit 27 as reproduction date and time in association with the content for which “view/reproduce” is instructed (step S41). The content processor 31 executes the process corresponding to the selected execution process (step S42) relative to the content to be processed, to finish the process.

According to the user interface apparatus 3 in the second embodiment, the execution process corresponding to the characteristic of the content can be presented to the user based on the timewise characteristic (space-time characteristic) relating to reproduction of the content selected as an operation target and the characteristic (experience characteristic) relating to a reproduction state of the content material. Accordingly, because the screens according to the instruction input of the various execution processes can be unified regardless of the space-time characteristic and the experience characteristic of the respective contents, the operability can be improved and user's convenience can be improved.

In the second embodiment, the searched contents are list-displayed under control of the list-creation and display unit 33. Specifically, when the reproduction date and time are stored in the respective contents as the reproduction history or view history, the list-creation and display unit 33 calculates reproduction frequency of the respective contents based on the history of the reproduction date and time, to control so that the content having higher reproduction frequency is displayed at higher rank. Because the content having higher reproduction frequency is displayed at higher rank, user's convenience can be further improved.

In the second embodiment, it is recognized based on the reproduction date and time that reproduction of the content is performed. However, the present invention is not limited thereto, and it can be recognized that reproduction of the content is performed, using a binary flag indicating whether reproduction is performed.

A user interface apparatus 4 according to a third embodiment of the present invention is explained next. In the third embodiment, the user interface apparatus mounted on or additionally connected to a cooking unit such as an oven range is explained. Like reference numerals refer to like configuration in the first embodiment and explanations thereof will be omitted.

In the first and second embodiments, the content to be operated is TV broadcasting or data obtained by recording TV broadcasting, whereas in the third embodiment, the content to be operated is a recipe associated with cooking.

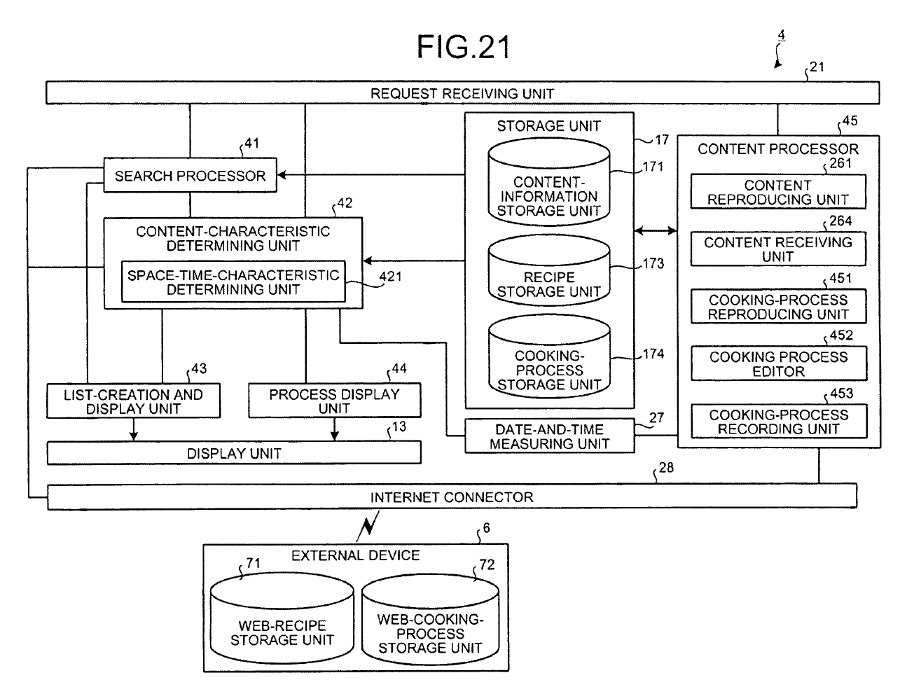

FIG. 21 is a block diagram of a functional configuration of the user interface apparatus 4. As shown in FIG. 21, the user interface apparatus 4 includes the request receiving unit 21, a search processor 41, a content-characteristic determining unit 42, a list-creation and display unit 43, a process display unit 44, a content processor 45, the date-and-time measuring unit 27, and the Internet connector 28.

The storage unit 17 according to the third embodiment includes a recipe storage unit 173 that stores the recipe and a cooking-process storage unit 174 that stores a cooking method in addition to the content-information storage unit 171.

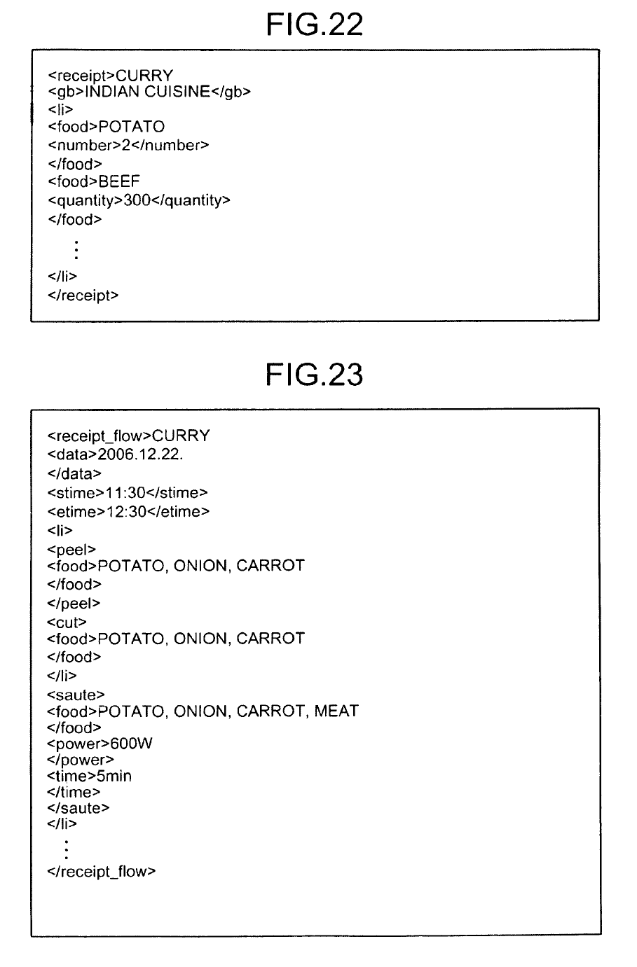

FIG. 22 is a diagram illustrating an example of the recipe stored in the recipe storage unit 173. As shown in FIG. 22, the recipe is described in the XML format. In FIG. 22, it is shown that text from <receipt> to </receipt> at the end indicates one recipe. A character string “curry”following <receipt> indicates a recipe name, and <gb>Indian cuisine</gb> indicates a cooking genre of the recipe name. From subsequent <li> to </li> indicates a food list for the recipe name.

In the food list, <food> indicates that data relating to food follows, and the end of the data is indicated by </food>. A numerical value surrounded by <number> and </number> indicates the number thereof, and a numeric value surrounded by <quantity> and </quantity> indicates the quantity thereof. For example, <food>potato<number>2</number></food> indicates two potatoes. In addition, <food>beef<quantity>300</quantity></food> indicates beef 300 grams.

FIG. 23 is a diagram illustrating an example of the cooking method stored in the cooking-process storage unit 174. As shown in FIG. 23, the cooking method is described in the XML format. It is indicated that text from <receipt_flow> to </receipt_flow > at the end indicates one cooking method, and that the method is a cooking method of “curry” indicated by a character string following <receipt_flow>. The name of the cooking method indicated by <receipt_flow> corresponds to the cooking recipe having the same recipe name, and the cooking method corresponding to the recipe can be read.

In FIG. 23, <date>2006.12.22</date>, <stime>11:30</stime>, and <etime>12:30</etime> indicate information added by a content processor 45 (a cooking-process recording unit 453) explained later, and respectively indicate date when the cooking method is executed, cooking start time, and cooking end time.

Text from <li> to </li> indicates one cooking process, and cooking processes put between <li> and </li> follow. In the respective cooking processes, text from <peel> to </peel> indicates a process for peeling materials indicated by <food>potato, onion, carrot</food> in a tag. Text from <cut> to </cut> indicates a process for cutting the material indicated by <food>potato, onion, carrot</food> in the tag. Text from <saute> to </saute> indicates a process of frying materials indicated by <food>potato, onion, carrot, meat</food> in the tag. Note that <power>600 W</power> and <time>5 min</time> described between <saute> and </saute>indicate that the materials are fried for 5 minutes with 600 watts of heat.

The external device 7 connected via the network includes a Web-recipe storage unit 71 that stores the recipe and a Web-cooking-process storage unit 72 that stores the cooking method. The Web-recipe storage unit 71 stores the recipe in the same format as in FIG. 22.

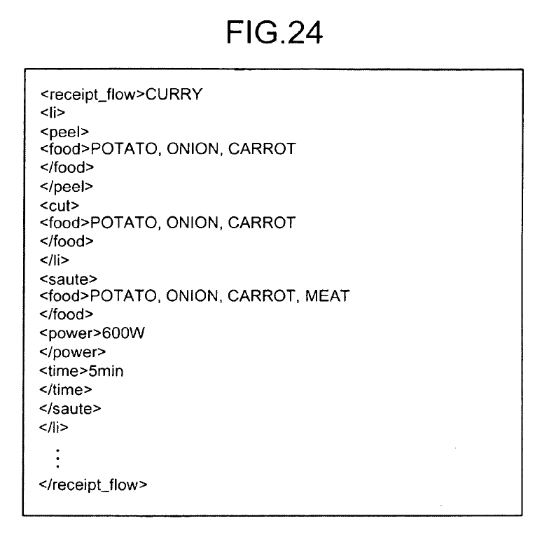

FIG. 24 is a diagram illustrating an example of the cooking method stored in the Web-cooking-process storage unit 72. As shown in FIG. 24, the cooking method stored in the Web-cooking-process storage unit 72 is in the same data format as in FIG. 23. A different point from the cooking method shown in FIG. 23 is that there is no data tag (part described from <data> to </data> added by the content processor 45 (the cooking-process recording unit 453) will be described later, a stime tag (part described from <stime> to </stime>), and an etime tag (part described from <etime> to </stime>).

The search processor 14 equipped in the user interface apparatus 4 according to the third embodiment searches the content (program data) including the keyword from the program guide in the content-information storage unit 171 based on the specific keyword input as a search key via the input unit 12 and outputs the content to the content-characteristic determining unit 42 and the list-creation and display unit 43 in the same manner as in the search processor 22.

The search processor 41 searches the content (recipe) that includes the keyword in the text from the recipe storage unit 173 and the Web recipe storage unit 71 based on the input specific keyword and outputs the content to the list-creation and display unit 43. The search processor 41 reads the cooking method corresponding to the searched recipe from the cooking-process storage unit 174 or the Web-cooking-process storage unit 72 and outputs the cooking method to the content-characteristic determining unit 42 together with the corresponding recipe.

The content-characteristic determining unit 42 includes a space-time-characteristic determining unit 421, to determine the space-time characteristic of the respective contents searched by the search processor 41, and outputs the determination result to the list-creation and display unit 43 and the process display unit 44.

The space-time-characteristic determining unit 421 compares current date and time measured by the date-and-time measuring unit 27 with broadcast date and time of respective contents (program data) included in the program guide in the content-information storage unit 171 and determines the space-time characteristic of the program being on the air as “present”. In the third embodiment, “past” and “future” are not determined as the space-time characteristic of the program. However, the present invention is not limited thereto, and the space-time characteristic “past” and “future” can be determined.

The content-characteristic determining unit 42 reads the cooking method corresponding to the content (recipe) searched by the search processor 41 from the cooking-process storage unit 174 and the Web-cooking-process storage unit 72. The content-characteristic determining unit 42 determines that the content including cooked time information in the cooking method, that is, the content stored in the cooking-process storage unit 174 has been actually cooked, and that the space-time characteristic thereof is “past”. The content-characteristic determining unit 42 determines that the content not including the cooked time information in the cooking method, that is, the content stored in the Web-cooking-process storage unit 72 has not been cooked, and that the space-time characteristic thereof is “future”.

The list-creation and display unit 43 divides the respective contents searched by the search processor 41 into each type of the space-time characteristics based on the determination result obtained by the content-characteristic determining unit 42 and a list thereof is displayed on the display unit 13.

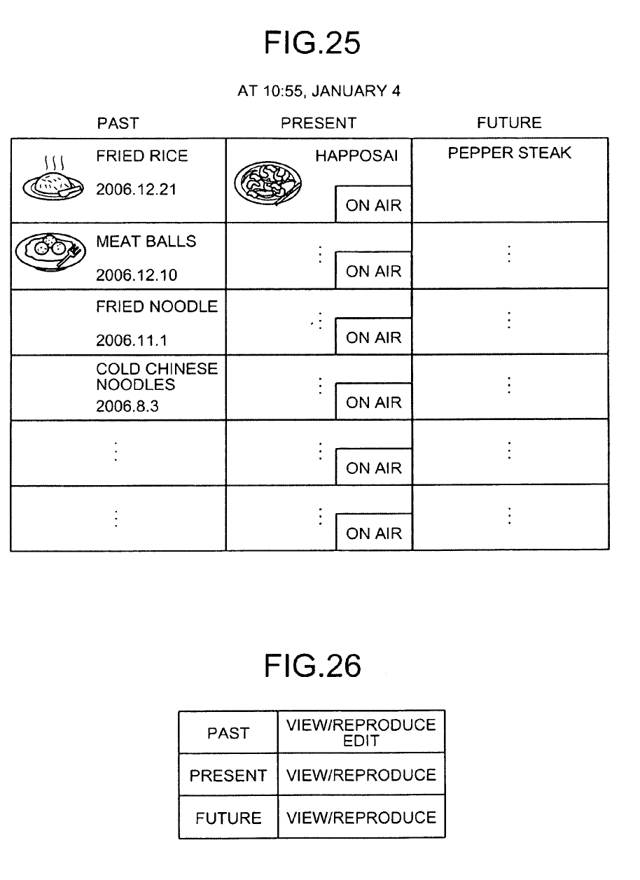

FIG. 25 is a diagram illustrating an example of a screen displayed on the display unit 13 by the list-creation and display unit 43. The result searched with cooking genre “Chinese cuisine” used as the search keyword is indicated here. As shown in the FIG. 25, the contents searched by the search processor 41 are listed in a state divided into “past”, “present”, and “future” according to the space-time characteristic thereof, under display control of the list-creation and display unit 24. “past” contents are displayed on the left of the screen, “present” contents are displayed in the middle, and “future” contents are displayed on the right of the screen. Because the “present” contents are on the air at present, “on the air” information indicating this matter is superimposed and displayed.

Returning to FIG. 21, when an instruction signal for selecting a specific content from the list of the contents displayed by the list-creation and display unit 43 has been received by the request receiving unit 21, the process display unit 44 displays a processing candidate list indicating a predetermined execution process with respect to the relevant content on the display unit 13 according to the determination result by the content-characteristic determining unit 42. The process display unit 44 refers to the processing candidate table in which the type (past, present, and future) of the space-time characteristics pre-stored in the ROM 14 or the storage unit 17 is associated with the predetermined execution process, to display the execution process corresponding to the selected content on the display unit 13.

FIG. 26 is a diagram illustrating an example of the processing candidate table used in the third embodiment. As shown in FIG. 26, the type (past, present, and future) of the space-time characteristics is registered in the processing candidate table in association with the execution process that can be processed in each type. In the space-time characteristic “past”, “view/reproduce” that instructs reproduction of the cooking method and “edit” that means edit of the cooking method are registered in association with each other. In the space-time characteristic “present”, “view/reproduce” that instructs reception of the content (program data) is registered in association with each other. In the space-time characteristic “future”, “view/reproduce” that instructs reproduction of the cooking method is registered in association with each other. Because display of the processing candidate list is performed as shown in FIGS. 8A, 8B, and 8C, explanations thereof will be omitted.

Returning to FIG. 21, the content processor 45 includes a cooking-process reproducing unit 451, a cooking process editor 452, and the cooking-process recording unit 453 in addition to the content reproducing unit 261 and the content receiving unit 264. When a specific process is instructed from the processing candidate list corresponding to the content displayed by the process display unit 44 with respect to the specific content displayed on the display unit 13 via the input unit 12, the respective functional units execute various processes corresponding to the instructed content.

When “view/reproduce” is instructed from the processing candidate list with respect to the specific content (recipe) having the space-time characteristic “past”, the cooking-process reproducing unit 451 obtains the cooking method corresponding to the recipe from the cooking-process storage unit 174 to reproduce the cooking method according to the instructed content. When “view/reproduce” is instructed from the processing candidate list with respect to the specific content (recipe) having the space-time characteristic “future”, the cooking-process reproducing unit 451 obtains the cooking method corresponding to the recipe from the Web-cooking-process storage unit 72 via the Internet connector 28 to reproduce the cooking method according to the instructed content. When the cooking method is obtained from the Web-cooking-process storage unit 72, the recipe corresponding to the cooking method is also obtained together, and the obtained recipe and cooking method are respectively stored in the recipe storage unit 173 and the cooking-method storage unit 174.

Reproduction of the cooking method stands for displaying various pieces of information on the display unit 13 according to the respective processes included in the cooking method and controlling an operation of a cooking unit (not shown) such as an induction heating (IH) heater. When the information instructing reproduction of motion picture data is included in the cooking method, the data is displayed on the display unit 13.

When “edit” is instructed from the processing candidate list with respect to the specific content (recipe) having the space-time characteristic “past”, the cooking process editor 452 obtains the cooking process corresponding to the recipe from the cooking-process storage unit 174 to display the information (GUI and the like) for supporting the edit of the cooking process on the display unit 13.

The cooking-process recording unit 453 obtains the current date and time from the date-and-time measuring unit 27 at the time of reproducing the cooking method by the cooking-process reproducing unit 451, and adds the date and time to the corresponding cooking method in the cooking-process storage unit 174 in a tag format (data tag, stime tag, and etime tag) as the cooking date and time. When the cooking date and time can be obtained from the cooking unit (not shown), the cooking date and time can be added to the corresponding cooking method stored in the cooking-process storage unit 174.

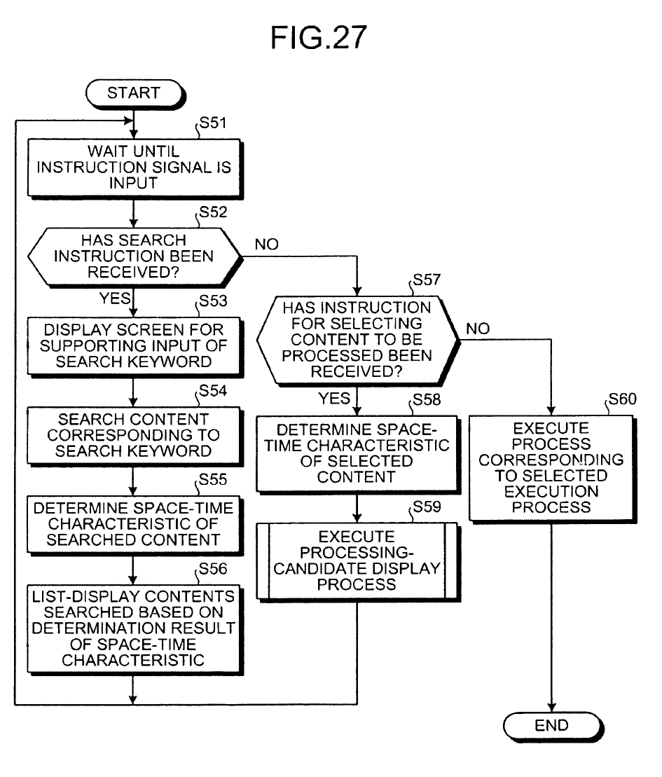

The operation of the user interface apparatus 4 in the third embodiment is explained with reference to FIG. 27. FIG. 27 is a flowchart of a display control process procedure performed by the user interface apparatus 4.

The process display unit 44 waits until the instruction signal is input via the input unit 12 (step S51). When determining that the instruction signal instructing search of a content has been received by the request receiving unit 21 (YES at step S52), the process display unit 44 displays the GUI for supporting the input of the search keyword on the display unit 13 (step S53).

Upon reception of the search keyword by the request receiving unit 21, the search processor 41 searches the content (program guide and recipe) including the character string matched with the input keyword from the program guide stored in the content-information storage unit 171 and recipes stored in the recipe storage unit 173 and the Web recipe storage unit 71 (step S54).

The content-characteristic determining unit 42 determines the space-time characteristic of the respective contents searched at step S54, and outputs the determination result to the list-creation and display unit 43 (step S55). The list-creation and display unit 43 list-displays the respective contents searched at step S54 based on the determination result obtained at step S55 for each type of the space-time characteristic (step S56), and returns to step S51.

At step S51, upon reception of an instruction signal selecting the content to be processed from the contents list displayed at step S56 by the request receiving unit 21 (NO at step S52 and YES at step S57), the content-characteristic determining unit 42 determines the space-time characteristic of the selected content and outputs the determination result to the process display unit 25 (step S58).

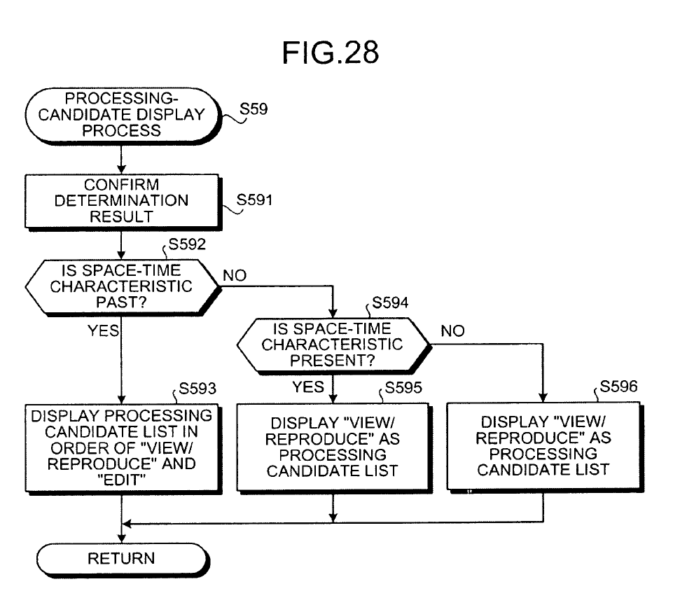

The process display unit 44 executes a processing-candidate display process (step S59) based on the determination result at step S58. The processing-candidate display process at step S59 is explained with reference to FIG. 28.

FIG. 28 is a flowchart of the procedure of the processing-candidate display process at step S59. At step S591, the process display unit 44 confirms the determination result (past, present, and future) at step S58 (step S591). When determining that the determination result of the space-time characteristic at step S58 is “past” (YES at step S592), the process display unit 44 refers to the processing candidate table, and displays on the display unit 13 the processing candidate list corresponding to the space-time characteristic, that is, the first processing candidate “view/reproduce” and the second processing candidate “edit” (step S593), to return to step S51 in FIG. 27.

When determining that the determination result of the space-time characteristic at step S58 is “present” (NO at step S592 and YES at step S594), the process display unit 44 refers to the processing candidate table and displays on the display unit 13 the processing candidate list corresponding to the space-time characteristic, that is, the first processing candidate “view/reproduce” (step S595), to return to step S51 in FIG. 27.

When determining that the determination result of the space-time characteristic at step S58 is “future” (NO at step S592 and NO at step S594), the process display unit 44 refers to the processing candidate table, and displays on the display unit 13 the processing candidate list corresponding to the space-time characteristic “future”, that is, the first processing candidate “view/reproduce” (step S596), to return to step S51 in FIG. 27.

Returning to FIG. 27, at step S51, upon reception of the instruction signal selecting a specific execution process from the processing candidate list displayed at step S59 via the input unit 12 by the request receiving unit 21 (NO at step S52 and NO at step S57), the content processor 45 executes the process corresponding to the selected execution process (step S60) relative to the content to be processed, to finish the process.

According to the user interface apparatus 4 in the third embodiment, the execution process corresponding to the characteristic of the content material can be presented to the user based on the timewise characteristic (space-time characteristic) relating to reproduction of the content selected as an operation target. Accordingly, because the screens according to the instruction input of the various execution processes can be unified regardless of the space-time characteristic of the respective contents, the operability can be improved and user's convenience can be improved.

A user interface apparatus 5 according to a fourth embodiment of the present invention is explained next. Like reference numerals refer to like configuration in the first to third embodiments and explanations thereof will be omitted.

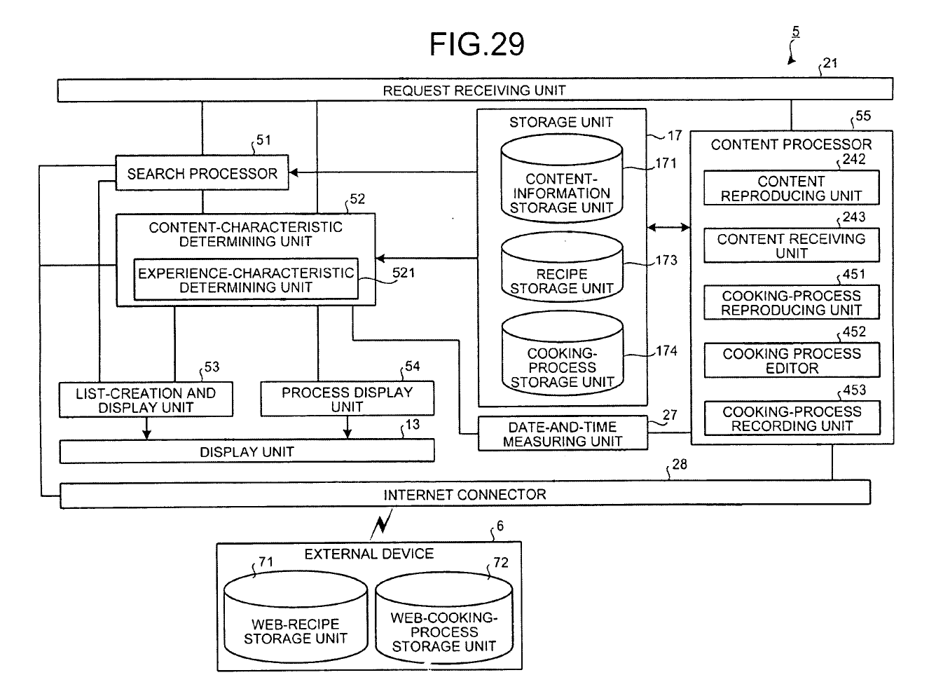

FIG. 29 is a block diagram of a functional configuration of the user interface apparatus 5. As shown in FIG. 29, the user interface apparatus 5 according to the fourth embodiment includes a search processor 51, a content-characteristic determining unit 52, a list-creation and display unit 53, a process display unit 54, and a content processor 55 respectively, instead of the search processor 41, the content-characteristic determining unit 42, the list-creation and display unit 43, the process display unit 44, and the content processor 45 explained in FIG. 21.

The search processor 51 searches the content (recipe) including the search keyword in the text from the recipe storage unit 173 and the Web recipe storage unit 71 based on the search keyword and outputs the content to the list-creation and display unit 43. The search processor 41 reads the cooking method corresponding to the searched recipe from the cooking-process storage unit 174 and the Web-cooking-process storage unit 72 to output the cooking method to the content-characteristic determining unit 52 together with the corresponding recipe.

The content-characteristic determining unit 52 includes an experience-characteristic determining unit 521, and determines the experience characteristic of respective contents searched by the search processor 51 and outputs the determination result to the list creation display unit 43 and the process display unit 44.

The experience-characteristic determining unit 521 determines whether the cooking date and time are included in the cooking method corresponding to the respective recipe searched by the search processor 51. The experience-characteristic determining unit 521 determines that cooking has been actually performed for the cooking method including the cooking date and time, and determines the experience characteristic as “experienced”. Further, the experience-characteristic determining unit 521 determines the experience characteristic as “unexperienced” for the cooking method not including the cooking date and time.

The list-creation and display unit 53 divides the respective contents searched by the search processor 51 into each type of experience characteristic and displays a list of the contents on the display unit 13 based on the determination result by the content-characteristic determining unit 52.

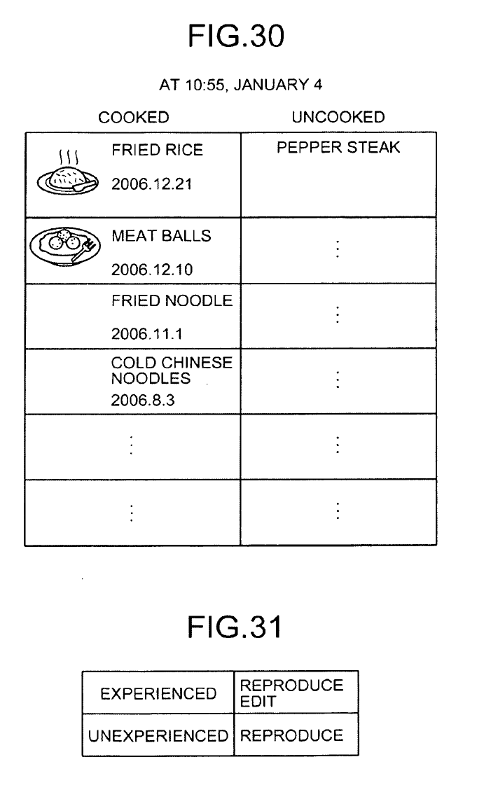

FIG. 30 is a diagram illustrating an example of the screen displayed on the display unit 13 by the list-creation and display unit 53. In FIG. 30, the result searched with cooking genre “Chinese cuisine” used as the search keyword is list-displayed. As shown in the FIG. 30, the respective contents searched by the search processor 51 are list-displayed in a state divided by the experience characteristic of “experienced” and “unexperienced” under display control by the list and creation display unit 53. The experience characteristics are list-displayed such that the experience characteristic “cooked” is positioned on the left of the screen and the experience characteristic “uncooked” is positioned on the right of the screen. In FIG. 30, on the upper part of the contents list, the current date and time are displayed, and “experienced” and “unexperienced” are rephrased and displayed as “cooked” and “uncooked”.

Returning to FIG. 29, when a specific content is selected via the input unit 12 from the contents list displayed by the list-creation and display unit 53, the process display unit 54 displays the processing candidate list indicating the predetermined execution process relative to the content on the display unit 13 according to the determination result by the content-characteristic determining unit 52. The process display unit 54 refers to the processing candidate table in which each type of the experience characteristic (cooked, uncooked) is associated with a predetermined execution process and stored in the ROM 14 or the storage unit 17 in advance, and displays the execution process corresponding to the selected content.

FIG. 31 is a diagram illustrating an example of the processing candidate table used in the fourth embodiment. As shown in FIG. 31, the type (cooked, uncooked) of the experience characteristic is registered in the processing candidate table in association with the execution process that can be processed in each type. In the experience characteristic “cooked”, “reproduce” that instructs reproduction of the cooking method and “edit” that means edit of the cooking method are registered in association with the experience characteristic “cooked”. In the experience characteristic “uncooked”, “reproduce” that instructs reproduction of the cooking method is registered in association therewith. Because the processing candidate list is displayed in the same manner as in FIGS. 8A, 8B, and 8C, explanations thereof will be omitted.

Returning to FIG. 29, the content processor 55 includes a cooking-process reproducing unit 551, a cooking process editor 552, and the cooking-process recording unit 453 in addition to the content reproducing unit 261 and the content receiving unit 264. When a specific process is instructed from the processing candidate list corresponding to the content displayed by the process display unit 44 with respect to the specific content displayed on the display unit 13 via the input unit 12, the respective functional units execute various processes according to the instructed content.

When “reproduce” is instructed from the processing candidate list with respect to the specific content (recipe) having the experience characteristic “cooked”, the cooking-process reproducing unit 551 obtains the cooking method corresponding to the recipe from the cooking-process storage unit 174 to reproduce the cooking method according to the instructed content. When “reproduce” is instructed from the processing candidate list with respect to the specific content (recipe) having the experience characteristic “uncooked”, the cooking-process reproducing unit 551 obtains the cooking method corresponding to the recipe from the Web-cooking-process storage unit 72 via the Internet connector 28 to reproduce the cooking method according to the instructed content. When the cooking method is obtained from the Web-cooking-process storage unit 72, the recipe corresponding to the cooking method is also obtained together, and the obtained recipe and cooking method are respectively stored in the recipe storage unit 173 and the cooking-method storage unit 174.

When “edit” is instructed from the processing candidate list with respect to the specific content (recipe) having the experience characteristic “cooked, the cooking process editor 552 obtains the cooking method corresponding to the recipe from the cooking-process storage unit 174 to display the information (GUI and the like) for supporting the edit of the cooking process included in the cooking method on the display unit 13.

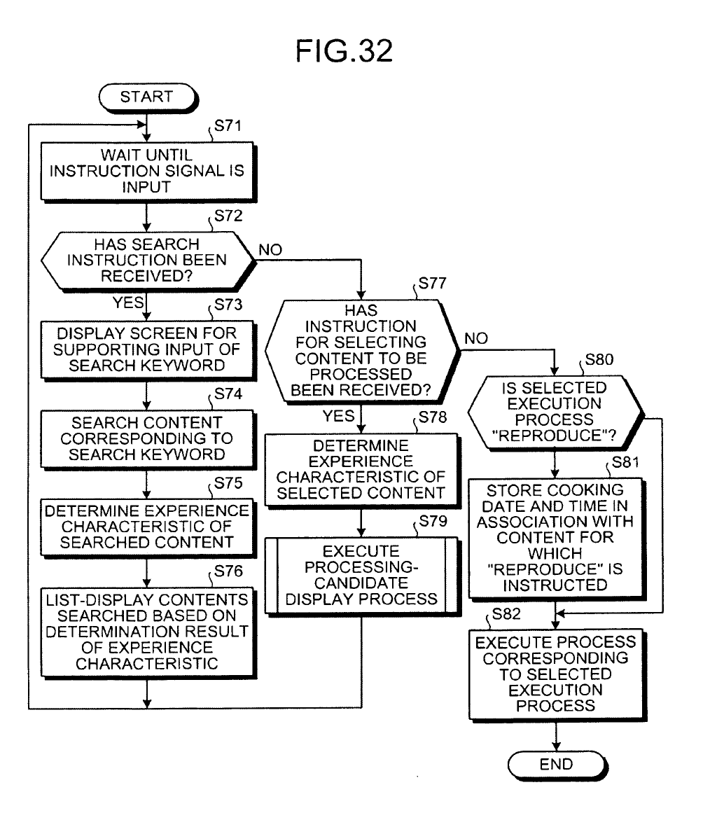

The operation of the user interface apparatus 5 according to the fourth embodiment is explained with reference to FIG. 32. FIG. 32 is a flowchart of a display control process procedure performed by the user interface apparatus 5.

The process display unit 54 waits until the instruction signal is input via the input unit 12 (step S71). When determining that the instruction signal instructing search of a content has been received by the request receiving unit 21 (YES at step S72), the process display unit 44 displays the GUI for supporting the input of the search keyword on the display unit 13 (step S73).

Upon reception of the search keyword by the request receiving unit 21, the search processor 51 searches the content (recipe) including the character string matched with the search keyword from the recipe stored in the recipe storage unit 173 and the Web recipe storage unit 71 (step S74).

The content-characteristic determining unit 52 determines the experience characteristic of the respective contents searched at step S74, and outputs the determination result to the list-creation and display unit 53 (step S75). The list-creation and display unit 53 list-displays the respective contents searched at step S74 based on the determination result at step S75 for each type of the experience characteristic (step S76), and returns to step S71.

At step S71, upon reception of an instruction signal selecting the content to be processed from the contents list displayed at step S76 by the request receiving unit 21 (NO at step S72 and YES at step S77), the content-characteristic determining unit 52 determines the experience characteristic of the selected content and outputs the determination result to the process display unit 54 (step S78).

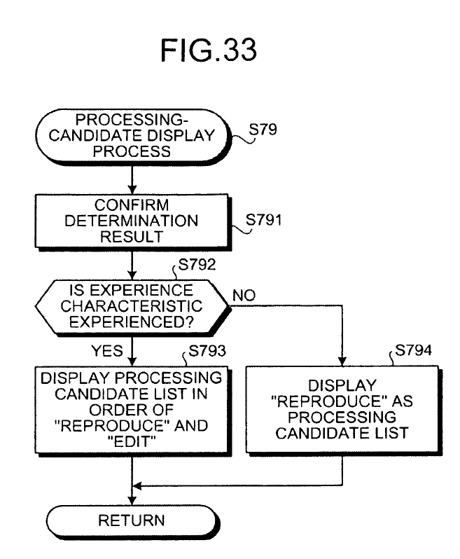

The process display unit 54 executes a processing-candidate display process (step S79) based on the determination result at step S78. The processing-candidate display process at step S79 is explained with reference to FIG. 33.

FIG. 33 is a flowchart of the procedure of the processing-candidate display process at step S79. At step S791, the process display unit 54 confirms the determination result (cooked or uncooked) at step S78 (step S791). When determining that the determination result of the experience characteristic at step S78 is “cooked” (YES at step S792), the process display unit 54 refers to the processing candidate table, and displays on the display unit 13 the processing candidate list corresponding to the experience characteristic, that is, the first processing candidate “reproduce” and the second processing candidate “edit” (step S793), to return to step S71 in FIG. 32.

When determining that the determination result of the experience characteristic at step S78 is “uncooked” (NO at step S792), the process display unit 54 refers to the processing candidate table and displays on the display unit 13 the processing candidate list corresponding to the experience characteristic, that is, the first processing candidate “reproduce” (step S794), to return to step S71 in FIG. 32.

Returning to FIG. 32, at step S71, upon reception of the instruction signal selecting a specific execution process from the processing candidate list displayed at step S59 via the input unit 12 by the request receiving unit 21 (NO at step S72 and NO at step S77), the content processor 55 determines whether the selected execution process is “reproduce” (step S80). When determining that the process other than “reproduce”, that is “edit” of the content is instructed (NO at step S80), the content processor 55 executes a process corresponding to the selected execution process with respect to the content to be processed (step S82), to finish the process.

On the other hand, at step S80, when it is determined that “reproduce” is selected (YES at step S80), the content processor 55 (the cooking-process recording unit 453) stores the current time measured by the date-and-time measuring unit 27 as the cooking date and time in association with the content, for which “reproduce” is instructed (step S81). The content processor 55 then executes a process corresponding to the selected execution process with respect to the content to be processed (step S82), to finish the process.

According to the user interface apparatus 5 in the fourth embodiment, the execution process corresponding to the characteristic of the content material can be presented to the user based on the characteristic (experience characteristic) relating to the reproduced state of the content selected as an operation target. Accordingly, because the screens according to the instruction input of the various execution processes can be unified regardless of the reproduction characteristic of the respective contents, the operability can be improved and user's convenience can be improved.

While the embodiments of the present invention have been explained above, the invention is not limited thereto. Various changes, substitutions, additions and the like can be made without departing from the scope of the present invention.

The program executed by the user interface apparatus in the embodiments is built in the ROM 14 or the storage unit 17. However, the program can be provided by recording the program on a computer readable recording medium such as CD-ROM, flexible disk (FD), CD-R, digital versatile disk (DVD) in a file in an installable format or executable format. The program can be stored on a computer connected to the network such as the Internet and provided by downloading the program via the network. The program can be further provided or distributed via the network such as the Internet.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A user interface apparatus comprising:
a first storage unit that stores a content material of a first content which is reproducible constantly and content information describing information relating to a reproduction of a second content which is reproducible on a predetermined time and date;
a first receiving unit that receives an input of a search key;
a search unit that searches at least one of the content material and the content information corresponding to the search key as operation candidate contents, from the first storage unit;
a date-and-time measuring unit that measures current date and time;
a characteristic determining unit that determines a timewise characteristic relating to reproduction of the operation candidate contents based on the current date and time;
a first display unit that list-displays the operation candidate contents for each type of the characteristic determined by the characteristic determining unit;
a second receiving unit that receives a selection instruction of a specific operation candidate content from the operation candidate contents displayed by the first display unit, and designates the content corresponding to the selection instruction as a content to be operated;
a second storage unit that stores a processing candidate table in which each type of the characteristic is associated with one or a plurality of execution processes corresponding to each type of the characteristic; and
a second display unit that displays an execution process corresponding to the characteristic of the content to be operated based on the processing candidate table stored in the second storage unit.

2. The apparatus according to claim 1, wherein the second display unit list-displays a plurality of the execution processes in a predetermined order.

3. The apparatus according to claim 2, wherein a priority level is set to the execution processes for each type of characteristic and is stored in the processing candidate table, and the second display unit list-displays the execution processes in an order corresponding to the priority level.

4. The apparatus according to claim 1, wherein the content information includes date and time information indicating date and time when a second content associated with the content information can be reproduced; and
the characteristic determining unit determines the characteristic based on a timewise relation between the current date and time and the date and time information included in the operation candidate content.

5. The apparatus according to claim 1, wherein the characteristic determining unit determines the characteristic based on whether the content material as the operation candidate content is stored in the first storage unit at the current date and time.

6. The apparatus according to claim 1, wherein the characteristic determining unit divides the operation candidate content into three categories of past, present, and future.

7. A user interface apparatus comprising:
a first storage unit that stores a content material of a first content which is reproducible constantly, content information describing information relating to a reproduction of a second content which is reproducible on a predetermined time and date, and reproduced information indicating whether any of the first and second contents are reproduced, in association with each other;
a first receiving unit that receives an input of a search key;
a search unit that searches at least one of the content material and the content information corresponding to the search key as operation candidate contents, from the first storage unit;
a characteristic determining unit that determines a characteristic relating to a reproduced state of the operation candidate content based on the reproduced information associated with the operation candidate contents;
a first display unit that list-displays the operation candidate contents for each type of the characteristic determined by the characteristic determining unit;
a second receiving unit that receives a selection instruction of a specific operation candidate content from the operation candidate contents displayed by the first display unit, and designates the content corresponding to the selection instruction as a content to be operated;
a second storage unit that stores a processing candidate table in which each type of the characteristic is associated with one or a plurality of execution processes corresponding to each type of the characteristic; and
a second display unit that displays an execution process corresponding to the characteristic of the content to be operated based on the processing candidate table stored in the second storage unit.

8. The apparatus according to claim 7, wherein the second display unit list-displays a plurality of the execution processes in a predetermined order.

9. The apparatus according to claim 8, wherein a priority level is set to the execution processes for each type of characteristic and is stored in the processing candidate table, and the second display unit list-displays the execution processes in an order corresponding to the priority level.

10. The apparatus according to claim 7, further comprising:
a third receiving unit that receives a reproduction instruction of a specific content from the first and second contents that are associated with the content material and the content information, respectively and stored in the first storage unit;
a reproducing unit that reproduces the specific content; and
a reproduction managing unit that stores the reproduced information in association with the content material or the content information corresponding to the first and second content, respectively during reproducing the content.

11. The apparatus according to claim 10, wherein
the third receiving unit receives a reproduction instruction of the specific operation candidate content based on the execution process displayed by the second display unit, and
the reproducing unit reproduces the content instructed by the content material or the content information corresponding to the specific operation candidate content.

12. The apparatus according to claim 7, wherein the characteristic determining unit divides the operation candidate content into two categories of “reproduced” and “unreproduced”.

13. A method of displaying user interface comprising:
first receiving an input of a search key;
searching at least one of a content material of a first content which is reproducible constantly and content information describing information relating to a reproduction of a second content which is reproducible on a predetermined time and date corresponding to the search key as operation candidate contents, from a first storage unit that stores the content material and the content information;
measuring current date and time;
determining a timewise characteristic relating to reproduction of the operation candidate content based on the current date and time;
first list-displaying the operation candidate contents for each type of the characteristic determined in the determining;
second receiving a selection instruction of a specific operation candidate content from the operation candidate contents displayed in the first displaying, and designating the content corresponding to the selection instruction as a content to be operated; and
second displaying an execution process corresponding to the characteristic of the content to be operated based on the processing candidate table in which each type of the characteristic is associated with one or a plurality of execution processes corresponding to each type of the characteristic.

14. A computer program product having a computer readable medium including programmed instructions for displaying user interface, wherein the instructions, when executed by a computer, cause the computer to perform:
first receiving an input of a search key;
searching at least one of a content material of a first content which is reproducible constantly and content information describing information relating to a reproduction of a second content which is reproducible on a predetermined time and date corresponding to the search key as operation candidate contents, from a first storage unit that stores the content material and the content information;
measuring current date and time;
determining a timewise characteristic relating to reproduction of the operation candidate content based on the current date and time;
first list-displaying the operation candidate contents for each type of the characteristic determined in the determining;
second receiving a selection instruction of a specific operation candidate content from the operation candidate contents displayed in the first displaying, and designating the content corresponding to the selection instruction as a content to be operated; and
second displaying an execution process corresponding to the characteristic of the content to be operated based on the processing candidate table in which each type of the characteristic is associated with one or a plurality of execution processes corresponding to each type of the characteristic.

15. A computer program product having a computer readable medium including programmed instructions for displaying user interface, wherein the instructions, when executed by a computer, cause the computer to perform:
first receiving an input of a search key;
searching at least one of a content material of a first content which is reproducible constantly and content information describing information relating to a reproduction of a second content which is reproducible on a predetermined time and date corresponding to the search key as operation candidate contents, from a first storage unit that stores the content material, the content information and reproduced information indicating whether any of the first and second contents are reproduced;
determining a characteristic relating to a reproduced state of the operation candidate content based on the reproduced information that is associated with the operation candidate content;
first list-displaying the operation candidate content for each type of the characteristic determined in the determining;
second receiving a selection instruction of a specific operation content from the operation candidate contents displayed in the first displaying, and designating the content as a content to be operated; and
second list-displaying an execution process corresponding to the characteristic of the content to be operated based on a processing candidate table in which each type of the characteristic is associated with one or a plurality of execution processes corresponding to each type of the characteristic.
